(19) United States
(12) Patent Application Publication
(10) Pub. No.: US 2026/0236750 A1
(43) Pub. Date: Aug. 13, 2026

(54) MACHINE-BASED LLM OUTPUT SUPERVISION

(71) Applicant: Bank of America Corporation, Charlotte, NC (US)

(72) Inventors: Pushkar Taneja, Hyderabad Telangana (IN); Suryanarayana Adivi, Hyderabad Telangana (IN); Jemlin Lucas, Addison, TX (US); Shilpa Sameer Sarang, Maharashtra (IN); Durga Prasad Kutthumolu, Hyderabad Telangana (IN)

(21) Appl. No.: 19/049,736

(22) Filed: Feb. 10, 2025

(51) Int. Cl. G06N 3/0475; G06N 10/60

(52) U.S. Cl. CPC G06N 3/0475; G06N 10/60

(57) ABSTRACT

Apparatus and methods for high-dimension validation of large language model (“LLM”) output. The apparatus and methods may leverage the power of Hybrid AI/ML and Quantum GANs to scrutinize LLM output from various angles. The apparatus and methods may discriminate between LLM-generated and verified facts. The methods may include analyzing the information provided by LLMs through different lenses, including metaphors, emotions, video, image analysis, cultural context, and simulations, utilizing Hybrid AI/ML models to identify patterns and relationships. This may enable a more accurate understanding of the data and help identify any inconsistencies or discrepancies in the output. The apparatus and methods may incorporate analysis to evaluate the implications of the information provided by LLMs and ensure that it aligns with standards and guidelines, utilizing Quantum GANs to generate alternative scenarios and assess the reliability of the data.

### FIELD OF TECHNOLOGY

Aspects of the disclosure relate to providing high-dimension validation of large language model (“LLM”) output.

### BACKGROUND

Despite advancements in technology, the accuracy and reliability of information provided by large language models (“LLMs) in the banking and finance sector remains a concern. Financial institutions typically rely on such models or other forms of artificial intelligence (“AI”) to make informed decisions regarding investments, risk management, and customer relations.

In January 2021, the stock trading app Robinhood faced challenges after restricting trading in certain securities, including GameStop, during a period of high volatility. This incident raised concerns about the reliability of information and decision-making processes in financial platforms that use algorithms and automated systems. Users questioned the transparency and fairness of Robinhood's actions, highlighting the need for accurate and reliable information in financial technology platforms to prevent potential harm to investors.

In March 2021, Archegos Capital Management, a family office run by Bill Hwang, faced a significant margin call leading to massive losses for various banks and financial institutions. The collapse of Archegos illustrated possible risks associated with relying on complex financial instruments and algorithms without proper oversight and risk management. This incident underscored the importance of accurate information and robust risk assessment techniques in the finance sector to avoid disruptions.

The data analytics firm Cambridge Analytica misused personal information from Facebook users to influence political campaigns, showcasing the potential concerns and risks associated with relying on algorithms for decision-making. This incident highlighted the importance of ensuring data accuracy and integrity in AI models.

It would be desirable therefore to provide apparatus and methods for high-dimension validation of large language model (“LLM”) output.

### SUMMARY

Apparatus and methods for verifying the accuracy and factual nature of information generated by Large Language Models (LLMs) are provided. The apparatus and methods may include comprehensive and multi-faceted techniques that may include methods of assessing the veracity of the data.

The apparatus and methods may analyze LLM output based on one or more of metaphors, emotions, and simulations, and identification of patterns and relationships.

The apparatus and methods may include, or may use, quantum generative adversarial networks (“GANs”) to generate alternative scenarios and assess the reliability of the data. Psycholinguistic profiling may be used to assess linguistic patterns and psychological aspects of the data. Counterfactual reasoning may be applied to explore alternative scenarios and assess the reliability of the data.

Apparatus and methods for high-dimension validation of large language model (“LLM”) output.

The apparatus and methods may leverage the power of Hybrid AI/ML and Quantum GANs to scrutinize LLM output from various angles. The apparatus and methods may include multiple distinct methods to assess the veracity of the data, ensuring that it is not merely generated but based on actual facts.

The methods may include analyzing the information provided by LLMs through different lenses, including metaphors, emotions, video, image analysis, cultural context, and simulations, utilizing Hybrid AI/ML models to identify patterns and relationships. This may enable a more accurate understanding of the data and help identify any inconsistencies or discrepancies in the output.

The apparatus and methods may incorporate analysis to evaluate the implications of the information provided by LLMs and ensure that it aligns with standards and guidelines, utilizing Quantum GANs to generate alternative scenarios and assess the reliability of the data. The methods may include psycholinguistic profiling, which may assess the linguistic patterns and psychological aspects of the data, providing insights into the credibility of the information.

The methods may include counterfactual reasoning to explore alternative scenarios and assess the reliability of the data based on different hypothetical situations, utilizing Hybrid AI/ML models to analyze the output and identify potential inaccuracies or misleading data.

The methods may include receiving LLM output from an LLM. The LLM May include an encoder. The LLM May include a decoder. The LLM may include one or more multi-head attention layers. The LLM may include one or more add & norm layers. The LLM May include one or more feed forward layers. The LLM May include a linear layer. The LLM May include a Softmax layer.

The LLM output may be responsive to a first query. The first query may be a query that is provided by a user of the LLM. The first query may include text. The first query may include an image. The first query may include a vocalization. The first query may include sound.

The methods may include feeding the LLM output to a Quantum-Boosted Metaphor Analyzer. The methods may include feeding the LLM output to a Quantum-machine learning (“ML”) Multimodal Fact-Checker. The methods may include feeding the LLM output to a AI-Quantum Cultural Context Decoder. The methods may include feeding the LLM output to a Simulation-Integrated Verification System. The methods may include feeding the LLM output to an Insight Extraction Engine. The methods may include feeding the LLM output to a Hybrid Domain-specific Truth Tester. The methods may include feeding the LLM output to a Counterfactual Reasoning Accelerator. The methods may include feeding the LLM output to a Quantum-inspired Fact Verification engine.

The methods may include feeding the LLM output to some or all of the foregoing. The methods may include feeding the LLM output to one or more of the foregoing in parallel with each other. The methods may include feeding the LLM output to one or more of the foregoing sequentially. The methods may include feeding the LLM output to one or more of the foregoing and conveying output from one of the foregoing to another of the foregoing.

The methods may include receiving one or more verification indications. A verification indication may include information that is generated independently from the LLM. A verification indication may include information that is independent from data upon which the LLM was trained. The information may corroborate, in part or in whole, the LLM output. The information may contradict, in part or in whole, the LLM output. The verification indications may be used to generate prevent or reduce the likelihood that LLM output lead to undesirable or inaccurate outcomes.

The verification indications may be used to improve the performance of the LLM. The verification indications may be added to query Q and resubmitted to LLM transformer model T.

The methods may include receiving a verification indication from the Quantum-Boosted Metaphor Analyzer. The methods may include receiving a verification indication from the Quantum-ML Multimodal Fact-Checker. The methods may include receiving a verification indication from the AI-Quantum Cultural Context Decoder. The methods may include receiving a verification indication from the Simulation-Integrated Verification System. The methods may include receiving a verification indication from the Insight Extraction Engine. The methods may include receiving a verification indication from the Hybrid Domain-specific Truth Tester. The methods may include receiving a verification indication from the Counterfactual Reasoning Accelerator. The methods may include receiving a verification indication from the Quantum-inspired Fact Verification engine.

The methods may include receiving verification indications from some or all of the foregoing. The methods may include receiving verification indications from one or more of the foregoing in parallel with each other. The methods may include receiving verification indications from one or more of the foregoing sequentially. The methods may include receiving verification indications from one or more of the foregoing and conveying one or more of the verification indications to another of the foregoing.

The methods may include generating an indication report based on the indications. The methods may include determining a difference between the indication report and the LLM output. The methods may include defining, based on the difference, in a high-dimension vector database, a cautionary space that is detectable in a post-LLM attention layer in response to a second query.

The apparatus may include apparatus for providing high-dimension validation of large language model (“LLM”) output. The apparatus may include a multi-stage quantum generative adversarial network distribution engine. The multi-stage quantum generative adversarial network distribution engine may be configured to receive LLM output from the LLM, the LLM output responsive to a first query.

The multi-stage quantum generative adversarial network distribution engine may be configured to feed the LLM output to a Quantum-Boosted Metaphor Analyzer. The multi-stage quantum generative adversarial network distribution engine may be configured to feed the LLM output to a Quantum-ML Multimodal Fact-Checker. The multi-stage quantum generative adversarial network distribution engine may be configured to feed the LLM output to a AI-Quantum Cultural Context Decoder. The multi-stage quantum generative adversarial network distribution engine may be configured to feed the LLM output to a Simulation-Integrated Verification System. The multi-stage quantum generative adversarial network distribution engine may be configured to feed the LLM output to an Insight Extraction Engine. The multi-stage quantum generative adversarial network distribution engine may be configured to feed the LLM output to a Hybrid Domain-specific Truth Tester. The multi-stage quantum generative adversarial network distribution engine may be configured to feed the LLM output to a Counterfactual Reasoning Accelerator. The multi-stage quantum generative adversarial network distribution engine may be configured to feed the LLM output to a Quantum-inspired Fact Verification engine. The multi-stage quantum generative adversarial network distribution engine may be configured to feed the LLM output to any combination of two or more of the foregoing.

The multi-stage quantum generative adversarial network distribution engine may be configured to receive a verification indication from the Quantum-Boosted Metaphor Analyzer. The multi-stage quantum generative adversarial network distribution engine may be configured to receive a verification indication from the Quantum-ML Multimodal Fact-Checker. The multi-stage quantum generative adversarial network distribution engine may be configured to receive a verification indication from the AI-Quantum Cultural Context Decoder. The multi-stage quantum generative adversarial network distribution engine may be configured to receive a verification indication from the Simulation-Integrated Verification System. The multi-stage quantum generative adversarial network distribution engine may be configured to receive a verification indication from the Insight Extraction Engine. The multi-stage quantum generative adversarial network distribution engine may be configured to receive a verification indication from the Hybrid Domain-specific Truth Tester. The multi-stage quantum generative adversarial network distribution engine may be configured to receive a verification indication from the Counterfactual Reasoning Accelerator. The multi-stage quantum generative adversarial network distribution engine may be configured to receive a verification indication from the Quantum-inspired Fact Verification engine. The multi-stage quantum generative adversarial network distribution engine may be configured receive a verification indication from any combination of two or more of the foregoing.

The apparatus may include a high-dimension vector calculator. The high-dimension vector calculator may be configured to generate an indication report based on the indications. The high-dimension vector calculator may be configured to generate an indication report based on the indications. The high-dimension vector calculator may be configured to determine a difference between the indication report and the LLM output. The high-dimension vector calculator may be configured to, based on the difference, define a cautionary space that is detectable in response to a second query.

### BRIEF DESCRIPTION OF THE DRAWINGS

The objects and advantages of the disclosure will be apparent upon consideration of the following detailed description, taken in conjunction with the accompanying drawings, in which like reference characters refer to like parts throughout, and in which:

FIG. 1 shows illustrative apparatus that may be used in accordance with the principles of the invention.

FIG. 2 shows illustrative apparatus that may be used in accordance with the principles of the invention.

FIG. 3 shows illustrative apparatus that may be used in accordance with the principles of the invention.

FIG. 4 shows illustrative apparatus that may be used in accordance with the principles of the invention.

FIG. 5 shows illustrative architecture in accordance with the principles of the invention.

FIG. 6 shows illustrative information in accordance with the principles of the invention.

FIG. 7 shows illustrative information in accordance with the principles of the invention.

FIG. 8 shows illustrative architecture in accordance with the principles of the invention.

FIG. 9 shows illustrative usage in accordance with the principles of the invention.

FIG. 10 shows illustrative usage in accordance with the principles of the invention.

FIG. 11 shows illustrative usage in accordance with the principles of the invention.

FIG. 12 shows illustrative usage in accordance with the principles of the invention.

FIG. 13 shows illustrative usage in accordance with the principles of the invention.

FIG. 14 shows illustrative usage in accordance with the principles of the invention.

FIG. 15 shows illustrative usage in accordance with the principles of the invention.

FIG. 16 shows illustrative usage in accordance with the principles of the invention.

FIG. 17 shows illustrative usage in accordance with the principles of the invention.

FIG. 18 shows illustrative usage in accordance with the principles of the invention.

FIG. 19 shows illustrative usage in accordance with the principles of the invention.

FIG. 20 shows illustrative usage in accordance with the principles of the invention.

FIG. 21 shows illustrative usage in accordance with the principles of the invention.

FIG. 22 shows illustrative usage in accordance with the principles of the invention.

FIG. 23 shows illustrative steps in accordance with the principles of the invention.

FIG. 24 shows illustrative architecture in accordance with the principles of the invention.

FIG. 25 shows illustrative information in accordance with the principles of the invention.

FIG. 26 shows illustrative information in accordance with the principles of the invention.

FIG. 27 shows illustrative information in accordance with the principles of the invention.

FIG. 28 shows illustrative process steps in accordance with the principles of the invention.

FIG. 29 shows illustrative process steps in accordance with the principles of the invention.

The leftmost digit (e.g., “L”) of a three-digit reference numeral (e.g., “LRR”), and the two leftmost digits (e.g., “LL”) of a four-digit reference numeral (e.g., “LLRR”), generally identify the initial figure in which a part is called-out.

### DETAILED DESCRIPTION

Apparatus and methods for high-dimension validation of large language model (“LLM”) output are provided.

The apparatus and methods may leverage the power of Hybrid AI/ML and Quantum GANs to scrutinize LLM output from various angles. The apparatus and methods may include multiple distinct methods to assess the veracity of the data, ensuring that it is not merely generated but based on actual facts.

The methods may include analyzing the information provided by LLMs through different lenses, including metaphors, emotions, video, image analysis, cultural context, and simulations, utilizing Hybrid AI/ML models to identify patterns and relationships. This may enable a more accurate understanding of the data and help identify any inconsistencies or discrepancies in the output.

The apparatus and methods may incorporate analysis to evaluate the implications of the information provided by LLMs and ensure that it aligns with standards and guidelines, utilizing Quantum GANs to generate alternative scenarios and assess the reliability of the data. The methods may include psycholinguistic profiling, which may assess the linguistic patterns and psychological aspects of the data, providing insights into the credibility of the information.

The methods may include counterfactual reasoning to explore alternative scenarios and assess the reliability of the data based on different hypothetical situations, utilizing Hybrid AI/ML models to analyze the output and identify potential inaccuracies or misleading data.

The methods may include receiving LLM output from an LLM. The LLM May include an encoder. The LLM May include a decoder. The LLM may include one or more multi-head attention layers. The LLM may include one or more add & norm layers. The LLM May include one or more feed forward layers. The LLM May include a linear layer. The LLM May include a Softmax layer.

The LLM output may be responsive to a first query. The first query may be a query that is provided by a user of the LLM. The first query may include text. The first query may include an image. The first query may include a vocalization. The first query may include sound.

The methods may include feeding the LLM output to a Quantum-Boosted Metaphor Analyzer. The methods may include feeding the LLM output to a Quantum-machine learning (“ML”) Multimodal Fact-Checker. The methods may include feeding the LLM output to a AI-Quantum Cultural Context Decoder. The methods may include feeding the LLM output to a Simulation-Integrated Verification System. The methods may include feeding the LLM output to an Insight Extraction Engine. The methods may include feeding the LLM output to a Hybrid Domain-specific Truth Tester. The methods may include feeding the LLM output to a Counterfactual Reasoning Accelerator. The methods may include feeding the LLM output to a Quantum-inspired Fact Verification engine.

The methods may include feeding the LLM output to some or all of the foregoing. The methods may include feeding the LLM output to one or more of the foregoing in parallel with each other. The methods may include feeding the LLM output to one or more of the foregoing sequentially. The methods may include feeding the LLM output to one or more of the foregoing and conveying output from one of the foregoing to another of the foregoing.

The methods may include receiving one or more verification indications. A verification indication may include information that is generated independently from the LLM. A verification indication may include information that is independent from data upon which the LLM was trained. The information may corroborate, in part or in whole, the LLM output. The information may contradict, in part or in whole, the LLM output. The verification indications may be used to generate prevent or reduce the likelihood that LLM output lead to undesirable or inaccurate outcomes.

The verification indications may be used to improve the performance of the LLM. The verification indications may be added to query Q and resubmitted to LLM transformer model T.

The methods may include receiving a verification indication from the Quantum-Boosted Metaphor Analyzer. The methods may include receiving a verification indication from the Quantum-ML Multimodal Fact-Checker. The methods may include receiving a verification indication from the AI-Quantum Cultural Context Decoder. The methods may include receiving a verification indication from the Simulation-Integrated Verification System. The methods may include receiving a verification indication from the Insight Extraction Engine. The methods may include receiving a verification indication from the Hybrid Domain-specific Truth Tester. The methods may include receiving a verification indication from the Counterfactual Reasoning Accelerator. The methods may include receiving a verification indication from the Quantum-inspired Fact Verification engine.

The methods may include receiving verification indications from some or all of the foregoing. The methods may include receiving verification indications from one or more of the foregoing in parallel with each other. The methods may include receiving verification indications from one or more of the foregoing sequentially. The methods may include receiving verification indications from one or more of the foregoing and conveying one or more of the verification indications to another of the foregoing.

The methods may include generating an indication report based on the indications. The methods may include determining a difference between the indication report and the LLM output. The methods may include defining, based on the difference, in a high-dimension vector database, a cautionary space that is detectable in a post-LLM attention layer in response to a second query.

The methods may include, prior to the feeding, tokenizing the LLM output to produce LLM output tokens. The feeding may include providing the LLM output tokens. The methods may include, prior to the generating, assigning weights to the indications.

The methods may include chunking the indication report by sentence. The methods may include chunking the LLM output by sentence.

The methods may include formulating indication vectors from each of the indication report chunks. The methods may include formulating LLM output vectors from each of the LLM output chunks.

The determining may include quantifying a dissimilarity between the indication vectors and the LLM output vectors.

The determining may include quantifying a dissimilarity between an indication vector an LLM output vector.

The determining may include quantifying a dissimilarity between a first vector component and a second vector component. The indication vector may include the first vector component. The LLM output vector may includes the second vector component.

The dissimilarity may be a dissimilarity of a sequence of dissimilarities between the indication vector and the LLM output vector; and also the greatest dissimilarity between the indication vector and the LLM output vector.

The determining may include identifying a greatest dissimilarity between the indication vectors and the LLM output vectors.

The defining may include formulating a virtual zone around an LLM output vector corresponding to a dissimilarity.

The defining may include formulating a virtual zone around an LLM output vector corresponding to the greatest of the dissimilarities.

The formulating may include embedding the zone in the vector database.

The zone may be defined as the LLM output vector corresponding to the greatest dissimilarity.

The methods may include embedding in the vector database an indication vector corresponding to a dissimilarity.

The methods may include embedding in the vector database only an indication vector that corresponds to the greatest dissimilarity.

The LLM output may be a first LLM output. The methods may include receiving second LLM output corresponding to the second query. The methods may include annotating the second LLM output based on the cautionary space.

The formulating may include receiving a virtual zone parameter from a user.

The parameter may include a reference vector that defines a perimeter of the zone.

The methods may include providing a user with human-recognizable options for selection as the reference vector.

The options may include text. The options may include an image. The options may include sound.

The apparatus may include a quantum computing device. The quantum computing device may be configured to implement one or more generative adversarial network (“GAN”) tools.

The apparatus may include apparatus for providing high-dimension validation of large language model (“LLM”) output. The apparatus may include a multi-stage quantum generative adversarial network distribution engine. The multi-stage quantum generative adversarial network distribution engine may be configured to receive LLM output from the LLM, the LLM output responsive to a first query.

The multi-stage quantum generative adversarial network distribution engine may be configured to feed the LLM output to a Quantum-Boosted Metaphor Analyzer. The multi-stage quantum generative adversarial network distribution engine may be configured to feed the LLM output to a Quantum-ML Multimodal Fact-Checker. The multi-stage quantum generative adversarial network distribution engine may be configured to feed the LLM output to a AI-Quantum Cultural Context Decoder. The multi-stage quantum generative adversarial network distribution engine may be configured to feed the LLM output to a Simulation-Integrated Verification System. The multi-stage quantum generative adversarial network distribution engine may be configured to feed the LLM output to an Insight Extraction Engine. The multi-stage quantum generative adversarial network distribution engine may be configured to feed the LLM output to a Hybrid Domain-specific Truth Tester. The multi-stage quantum generative adversarial network distribution engine may be configured to feed the LLM output to a Counterfactual Reasoning Accelerator. The multi-stage quantum generative adversarial network distribution engine may be configured to feed the LLM output to a Quantum-inspired Fact Verification engine. The multi-stage quantum generative adversarial network distribution engine may be configured to feed the LLM output to any combination of two or more of the foregoing.

The multi-stage quantum generative adversarial network distribution engine may be configured to receive a verification indication from the Quantum-Boosted Metaphor Analyzer. The multi-stage quantum generative adversarial network distribution engine may be configured to receive a verification indication from the Quantum-ML Multimodal Fact-Checker. The multi-stage quantum generative adversarial network distribution engine may be configured to receive a verification indication from the AI-Quantum Cultural Context Decoder. The multi-stage quantum generative adversarial network distribution engine may be configured to receive a verification indication from the Simulation-Integrated Verification System. The multi-stage quantum generative adversarial network distribution engine may be configured to receive a verification indication from the Insight Extraction Engine. The multi-stage quantum generative adversarial network distribution engine may be configured to receive a verification indication from the Hybrid Domain-specific Truth Tester. The multi-stage quantum generative adversarial network distribution engine may be configured to receive a verification indication from the Counterfactual Reasoning Accelerator. The multi-stage quantum generative adversarial network distribution engine may be configured to receive a verification indication from the Quantum-inspired Fact Verification engine. The multi-stage quantum generative adversarial network distribution engine may be configured receive a verification indication from any combination of two or more of the foregoing.

The apparatus may include a high-dimension vector calculator. The high-dimension vector calculator may be configured to generate an indication report based on the indications. The high-dimension vector calculator may be configured to generate an indication report based on the indications. The high-dimension vector calculator may be configured to determine a difference between the indication report and the LLM output. The high-dimension vector calculator may be configured to, based on the difference, define a cautionary space that is detectable in response to a second query.

The high-dimension vector calculator is further configured to formulate a virtual zone around an LLM output vector corresponding to a dissimilarity between the indication report and the LLM output. The high-dimension vector calculator may be configured to embed the zone in the vector database. The zone may be defined as the LLM output vector corresponding to the greatest dissimilarity of a set of dissimilarities between the indication report and the LLM output.

The virtual zone may be defined as an indication vector corresponding to a dissimilarity.

The apparatus may include an overlay engine. The LLM output may be a first LLM output. The overlay engine may be configured to receive second LLM output corresponding to the second query. The overlay engine may be configured to annotate the second LLM output based on the cautionary space.

The high-dimension vector calculator may be configured to receive a virtual zone parameter from a user. The parameter may include a reference vector that defines a perimeter of the zone.

Illustrative embodiments of apparatus and methods in accordance with the principles of the invention will now be described with reference to the accompanying drawings, which form a part hereof. It is to be understood that other embodiments may be utilized, and structural, functional and procedural modifications may be made without departing from the scope and spirit of the present invention.

The drawings show illustrative features of apparatus and methods in accordance with the principles of the invention. The features are illustrated in the context of selected embodiments. It will be understood that features shown in connection with one of the embodiments may be practiced in accordance with the principles of the invention along with features shown in connection with another of the embodiments.

The apparatus and methods described herein are illustrative. Apparatus and methods of the invention may involve some or all of the features of the illustrative apparatus and/or some or all of the steps of the illustrative methods. The steps of the methods may be performed in an order other than the order shown or described herein. Some embodiments may omit steps shown or described in connection with the illustrative methods. Some embodiments may include steps that are not shown or described in connection with the illustrative methods, but rather shown or described in a different portion of the specification.

One of ordinary skill in the art will appreciate that the steps shown and described herein may be performed in other than the recited order and that one or more steps illustrated may be optional. The methods of the above-referenced embodiments may involve the use of any suitable elements, steps, computer-executable instructions, or computer-readable data structures. In this regard, other embodiments are disclosed herein as well that can be partially or wholly implemented on a computer-readable medium, for example, by storing computer-executable instructions or modules or by utilizing computer-readable data structures.

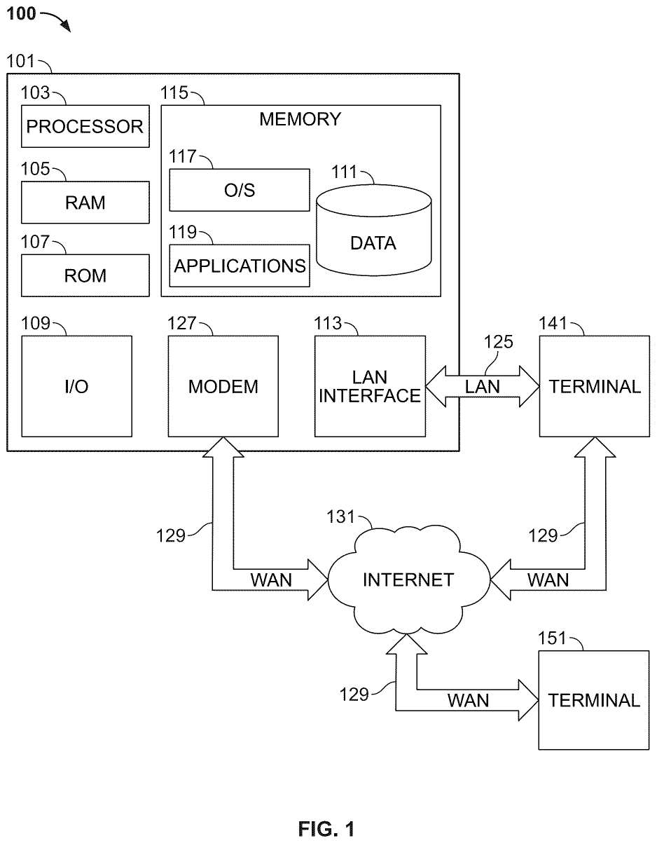

FIG. 1 shows an illustrative block diagram of system 100 that includes computer 101. Computer 101 may alternatively be referred to herein as an “engine,” “server” or a “computing device.” Computer 101 may be a workstation, desktop, laptop, tablet, smart phone, or any other suitable computing device. Elements of system 100, including computer 101, may be used to implement various aspects of the systems and methods disclosed herein. Each of the nodes, servers, computing devices, APIs, display monitors, databases and any other part of the disclosure may include some or all of apparatus included in system 100.

Computer 101 may have a processor 103 for controlling the operation of the device and its associated components and may include Random Access Memory (“RAM”) 105, Read Only Memory (“ROM”) 107, input/output circuit 109 and a non-transitory or non-volatile memory 115. Machine-readable memory may be configured to store information in machine-readable data structures. The processor 103 may also execute all software executing on the computer—e.g., the operating system and/or voice recognition software. Other components commonly used for computers, such as EEPROM or Flash memory or any other suitable components, may also be part of the computer 101.

Memory 115 may be comprised of any suitable permanent storage technology—e.g., a hard drive. Memory 115 may store software including the operating system 117 and application(s) 119 along with any data 111 needed for the operation of the system 100. memory 115 may also store videos, text and/or audio assistance files. Nodes, servers, computing devices, models, APIs, display monitors, databases and any other suitable computing device as disclosed herein may have one or more features in common with memory 115. The data stored in memory 115 may also be stored in cache memory, or any other suitable memory.

Input/output (“I/O”) module 109 may include connectivity to a microphone, keyboard, touch screen, mouse and/or stylus through which input may be provided into computer 101. The input may include input relating to cursor movement or keyboard input. The input/output module may also include one or more speakers for providing audio output and a video display device for providing textual, audio, audiovisual and/or graphical output. The input and output may be related to computer application functionality.

System 100 may be connected to other systems via a local area network (“LAN”) interface 113. System 100 may operate in a networked environment supporting connections to one or more remote computers, such as terminals 141 and 151. Terminals 141 and 151 may be personal computers or servers that include many or all of the elements described above relative to system 100. When used in a LAN networking environment, computer 101 is connected to LAN 125 through a LAN interface or adapter 113. When used in a Wide Area Network (“WAN”) networking environment, computer 101 may include a modem 127 or other means for establishing communications over WAN 129, such as Internet 131. Connections between System 100 and Terminals 151 and/or 141 may be used for the communication between different nodes and systems within the disclosure.

It will be appreciated if the network connections shown are illustrative and other means of establishing a communications link between computers may be used. The existence of various well-known protocols such as TCP/IP, Ethernet, FTP, HTTP and the like is presumed, and the system can be operated in a client-server configuration to permit retrieval of data from a web-based server or application programming interface (“API”). Web-based, for the purposes of this application, is to be understood to include a cloud-based system. The web-based server may transmit data to any other suitable computer system. The web-based server may also send computer-readable instructions, together with the data, to any suitable computer system. The computer-readable instructions may be configured to store the data in cache memory, the hard drive, secondary memory, or any other suitable memory.

Additionally, application program(s) 119, which may be used by computer 101, may include computer executable instructions for invoking functionality related to communication, such as e-mail, Short Message Service (“SMS”) and voice input and speech recognition applications. Application program(s) 119 (which may be alternatively referred to herein as “plugins,” “applications,” or “apps”) may include computer executable instructions for invoking functionality related to performing various tasks. Application programs 119 may utilize one or more algorithms that process received executable instructions, perform power management routines or other suitable tasks. Application programs 119 may utilize one or more decisioning processes.

Application program(s) 119 may include computer executable instructions (alternatively referred to as “programs”). The computer executable instructions may be embodied in hardware or firmware (not shown). Computer 101 may execute the instructions embodied by the application program(s) 119 to perform various functions.

Application program(s) 119 may utilize the computer-executable instructions executed by a processor. Generally, programs include routines, programs, objects, components, data structures, etc. that perform particular tasks or implement particular abstract data types. A computing system may be operational with distributed computing environments where tasks are performed by remote processing devices that are linked through a communications network. In a distributed computing environment, a program may be located in both local and remote computer storage media including memory storage devices. Computing systems may rely on a network of remote servers hosted on the Internet to store, manage and process data (e.g., “cloud computing” and/or “fog computing”).

Any information described above in connection with data 111 and any other suitable information, may be stored in memory 115. One or more of applications 119 may include one or more algorithms that may be used to implement features of the disclosure comprising the transmission, storage, and transmitting of data and/or any other tasks described herein.

The invention may be described in the context of computer-executable instructions, such as applications 119, being executed by a computer. Generally, programs include routines, programs, objects, components, data structures, etc., that perform particular tasks or implement particular data types. The invention may also be practiced in distributed computing environments where tasks are performed by remote processing devices that are linked through a communications network. In a distributed computing environment, programs may be located in both local and remote computer storage media including memory storage devices. It should be noted that such programs may be considered for the purposes of this application, as engines with respect to the performance of the particular tasks to which the programs are assigned.

Computer 101 and/or terminals 141 and 151 may also include various other components, such as a battery, speaker and/or antennas (not shown). Components of computer system 101 may be linked by a system bus, wirelessly or by other suitable interconnections. Components of computer system 101 may be present on one or more circuit boards. In some embodiments, the components may be integrated into a single chip. The chip may be silicon-based.

Terminal 151 and/or terminal 141 may be portable devices such as a laptop, cell phone, tablet, smartphone, or any other computing system for receiving, storing, transmitting and/or displaying relevant information. Terminal 151 and/or terminal 141 may be one or more data sources or a calling source. Terminals 151 and 141 may have one or more features in common with apparatus 101. Terminals 115 and 141 may be identical to system 100 or different. The differences may be related to hardware components and/or software components.

The invention may be operational with numerous other general purpose or special purpose computing system environments or configurations. Examples of well-known computing systems, environments and/or configurations that may be suitable for use with the invention include, but are not limited to, personal computers, server computers, hand-held or laptop devices, tablets, mobile phones, smart phones and/or other personal digital assistants (“PDAs”), multiprocessor systems, microprocessor-based systems, cloud-based systems, programmable consumer electronics, network PCs, minicomputers, mainframe computers, distributed computing environments that include any of the above systems or devices and the like.

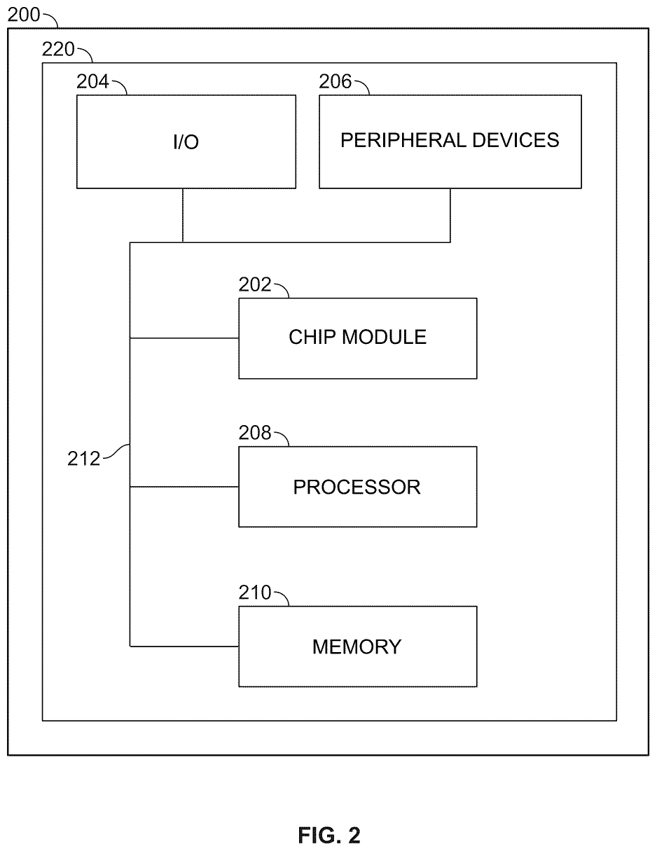

FIG. 2 shows illustrative apparatus 200 that may be configured in accordance with the principles of the disclosure. Apparatus 200 may be a computing device. Apparatus 200 may include one or more features of the apparatus shown in FIG. 2000. Apparatus 200 may include chip module 202, which may include one or more integrated circuits, and which may include logic configured to perform any other suitable logical operations.

Apparatus 200 may include one or more of the following components: I/O circuitry 204, which may include a transmitter device and a receiver device and may interface with fiber optic cable, coaxial cable, telephone lines, wireless devices, PHY layer hardware, a keypad/display control device or any other suitable media or devices; peripheral devices 206, which may include counter timers, real-time timers, power-on reset generators or any other suitable peripheral devices; logical processing device 208, which may compute data structural information and structural parameters of the data; and machine-readable memory 210.

Machine-readable memory 210 may be configured to store in machine-readable data structures: machine executable instructions, (which may be alternatively referred to herein as “computer instructions” or “computer code”), applications such as applications 119, signals and/or any other suitable information or data structures.

Components 202, 204, 206, 208 and 210 may be coupled together by a system bus or other interconnections 212 and may be present on one or more circuit boards such as 220. In some embodiments, the components may be integrated into a single chip. The chip may be silicon-based.

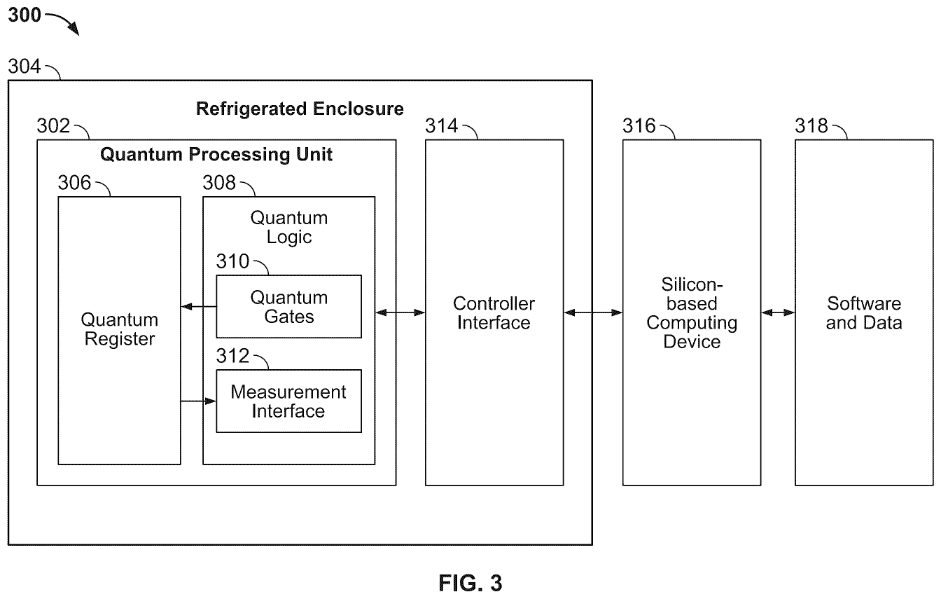

FIG. 3 shows illustrative block diagram of system 300. System 300 may include quantum processing unit 302. Quantum processing unit 302 may be a processing unit that uses quantum principles to perform tasks. Quantum processing unit 302 may include quantum register 306. Quantum processing unit 302 may include quantum logic 308. Quantum logic 308 may include quantum gates 310 and measurement interface 312.

Quantum register 306 may be comprised of qubits. Each qubit may have a state of either zero or one, like a classical bit. However, unlike a classical bit, a qubit may have a superposition state. The superposition state may be a state in which the qubit exists as all possible states simultaneously. In order to maintain the qubits in a superposed state, the qubits are preserved at close to absolute zero degrees (kelvin). Refrigerated enclosure 304 may maintain the qubits at close to absolute zero degrees (kelvin).

Quantum gates 310 may include quantum algorithms, such as algorithms based on amplitude amplification, algorithms based on the quantum Fourier transform, algorithms based on quantum walks and/or any other suitable quantum algorithms. Each algorithm may include a series of one or more quantum gates, such as but not limited to identity gates, Pauli gates, controlled gates, phase shift gates, Hadamard gates, swap gates and Toffoli gates. Measurement interface 312 may measure a state of each qubit after being processed by the algorithms included in quantum gates 310. The measured state of each qubit may be a finite state.

The measured state may be transmitted to controller interface 314. Controller interface 314 may enable information to be transmitted between quantum processing unit 302 and silicon-based computing device 316. The measured state may be transmitted to silicon-based computing device 316. Silicon-based computing device 316 may include software and data 318. Software and data 318 may be used to process the measured state that was transmitted from quantum processing unit 302. Silicon-based computing device 316 may transmit data included in software and data 318 to controller interface 314. Controller interface 314 may transmit the data to quantum processing unit 302 to be processed and analyzed.

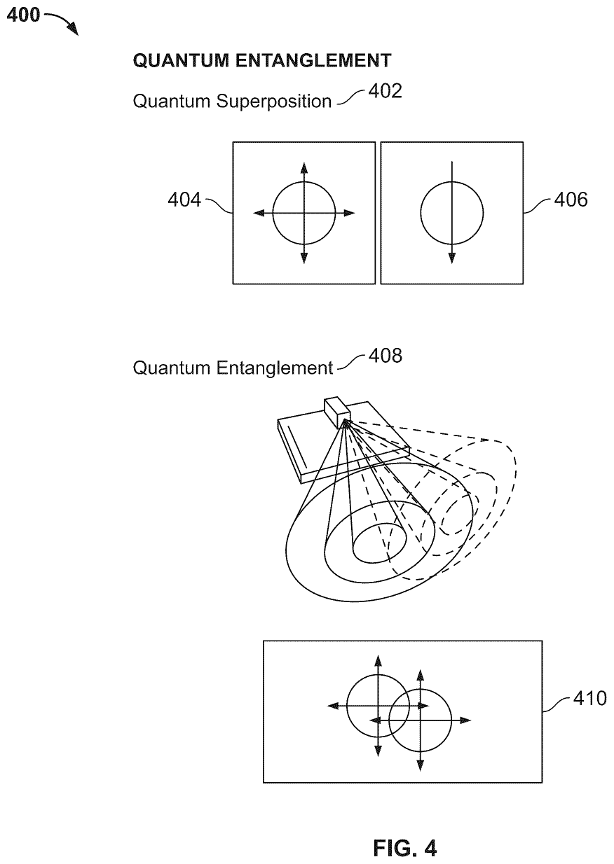

FIG. 4 shows illustrative diagram 400. Illustrative diagram 400 may have one or more features in common with system 800. Illustrative diagram 400 may include quantum superposition, as shown at 402. The rules of quantum physics state that an unobserved quantum particle, such as a photon, exists in all possible states simultaneously, as shown at 404. However, when observed or measured, the quantum particle collapses into one state, as shown at 406 (spin-down).

Quantum entanglement, shown at 408, may occur when two quantum particles become connected. A laser beam fired through a certain type of crystal can cause individual photons to be split into pairs of entangled photons. A pair of entangled particles may be shown at 410.

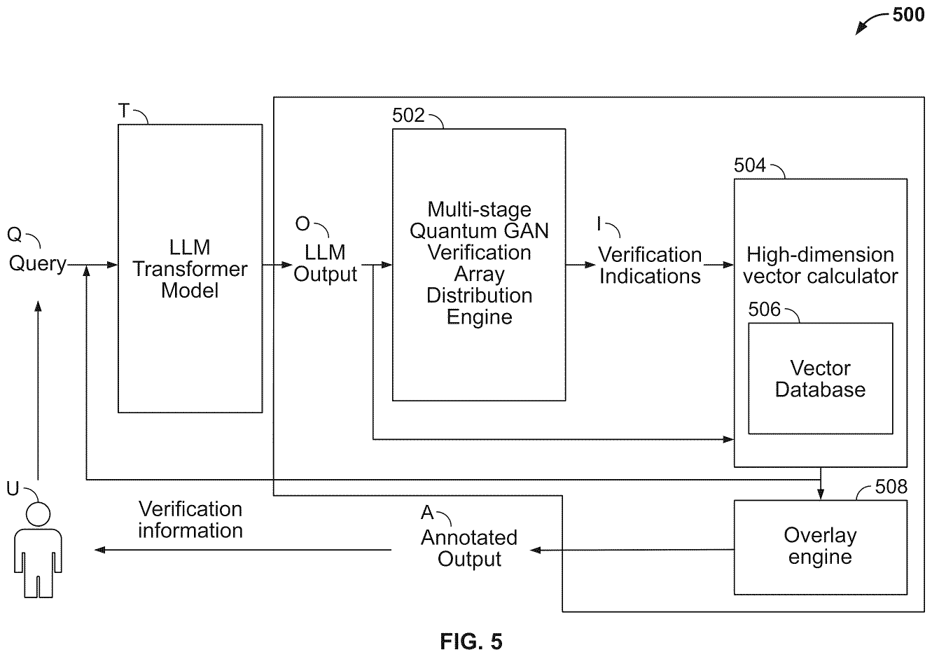

FIG. 5 shows illustrative architecture 500 for high-dimension validation of large language model (“LLM”) output. Architecture 500 may include multi-stage quantum GAN verification array distribution engine 502. Architecture 500 may include high-dimension vector calculator 504, which may include vector database 506. Architecture 500 may include overlay engine 508.

User U may submit query Q to LLM transformer model T. LLM transformer model T may have any suitable property or feature of a large language model or a large language model transformer. LLM transformer model T may create LLM output O based on query Q. Distribution engine 502 may receive LLM output O. Distribution engine 502 may generate one or more verification indications I. Distribution engine 502 may send indications I to high-dimension vector calculator 504. High-dimension vector calculator 504 may embed indications I in vector database 506. Vector database 506 may be defined based on numerous dimensions. The dimensions may include 2, 10, 100, 1,000, 10,000 dimensions or more, or any number of dimensions between 2 and 10,000 or more.

High-dimension vector calculator may receive LLM output O from LLM transformer model T. High-dimension calculator may embed LLM output O in vector database 506. High-dimension vector calculator 504 may identify dissimilarities between LLM output O and verification indication I. High-dimension vector calculator 504 provide verification information to an input of LLM transformer model T. Model may then operate on a revised query Q′=Q+(verification information). High-dimension vector calculator 504 may provide the verification information to overlay engine 508. Overlay engine 508 may provide to user U annotated output A.

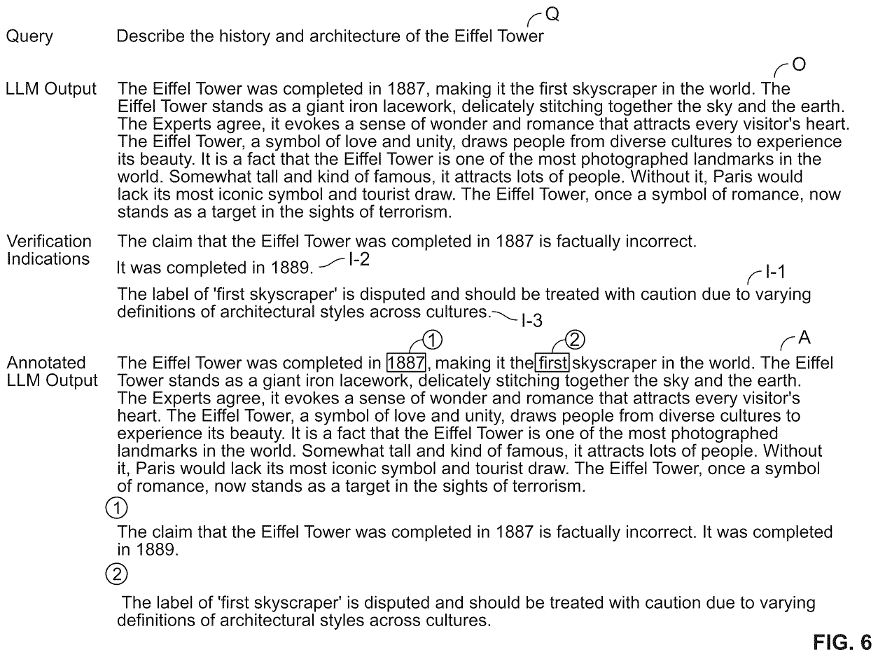

FIG. 6 shows illustrative query Q, LLM Output O, verification indications I-1, I-2 and I-3 and annotated output A. Annotated output A shows at “1” that “1887” is dissimilar to at least one of verification indications I-1-I-3. Annotated output A shows at “2” that “first” is dissimilar to at least one of verification indications I-1-I-3.

Table 1 lists illustrative categories of language analysis, along with illustrative language from LLM output O, that may be analyzed in accordance with the principles of the invention.

TABLE 1
Illustrative categories of language analysis,
along with illustrative language from LLM output O.
Illustrative categories of language analysis,
along with illustrative language from LLM output O.

| Categories | Language from LLM output O |
|---|---|
| Historical Date | “The Eiffel Tower was completed in 1887.” |
| Metaphor | “The Eiffel Tower, the first skyscraper in the world”. |
| Metaphor | “The Eiffel Tower stands as a giant iron lacework, |
| | delicately stitching together the sky and the earth.” |
| Emotion | “The Expert agree, The Eiffel Tower evokes a sense |
| | of wonder and romance that attracts every visitor's heart.” |
| Cross-Cultural | “The Eiffel Tower, a symbol of love and unity, draws |
| Context | people from diverse cultures to experience its beauty.” |
| Truth Tester | “It is a fact that the Eiffel Tower is one of the most |
| Context | photographed landmarks in the world.” |
| Vague Terms | “The Eiffel Tower is somewhat tall and kind of famous, |
| | attracting lots of people.” |
| Counterfactual | “If the Eiffel Tower had never been built, Paris would |
| Reasoning | lack its most iconic symbol and draw for tourists.” |

The apparatus and methods may be used to analyze LLM output O to confirm whether the Eiffel Tower is recognized as the first skyscraper.

The apparatus and methods may be used to analyze LLM output O to check the characterization of the Eiffel Tower as “iron lacework” and ensure that this description accurately reflects its architectural style, which includes wrought iron.

The apparatus and methods may be used to analyze LLM output O to validate the metaphor of the Eiffel Tower as a “giant iron lacework.” This requires evaluating whether this description is commonly used in literature or architecture critiques.

The apparatus and methods may be used to analyze LLM output O to analyze this metaphor for its appropriateness in conveying the tower's visual impact and architectural significance.

The apparatus and methods may be used to analyze LLM output O to examine the emotional associations of the Eiffel Tower. This might involve reviewing literature, tourist testimonials, or cultural references that highlight feelings of wonder and romance.

The apparatus and methods may be used to analyze LLM output O to validate this characterization against cultural representations and the tower's role in events (e.g., weddings, proposals).

The apparatus and methods may be used to analyze LLM output O to confirm the assertion that the Eiffel Tower attracts people from diverse cultures. This may require tourism statistics or studies about the demographics of Eiffel Tower visitors.

The apparatus and methods may be used to analyze LLM output O to investigate the Eiffel Tower's significance in various cultures and how it is perceived globally.

The apparatus and methods may be used to analyze LLM output O to verify the statement that the Eiffel Tower is one of the most photographed landmarks in the world. This may involve statistics on photography or surveys of iconic landmarks.

The apparatus and methods may be used to analyze LLM output O to cross-check visitor statistics to validate that the Eiffel Tower is a major tourist draw in Paris.

The apparatus and methods may be used to analyze LLM output O to assess the vagueness of these phrases. A system should define what “somewhat” and “kind of” mean in quantifiable terms (e.g., height rankings, fame metrics).

The apparatus and methods may be used to analyze LLM output O to determine what constitutes “lots” by analyzing visitor numbers or statistics.

The apparatus and methods may be used to analyze LLM output O to evaluate the counterfactual assertion by considering what other landmarks might fulfill a similar role in Paris and the impact on the city's identity and tourism.

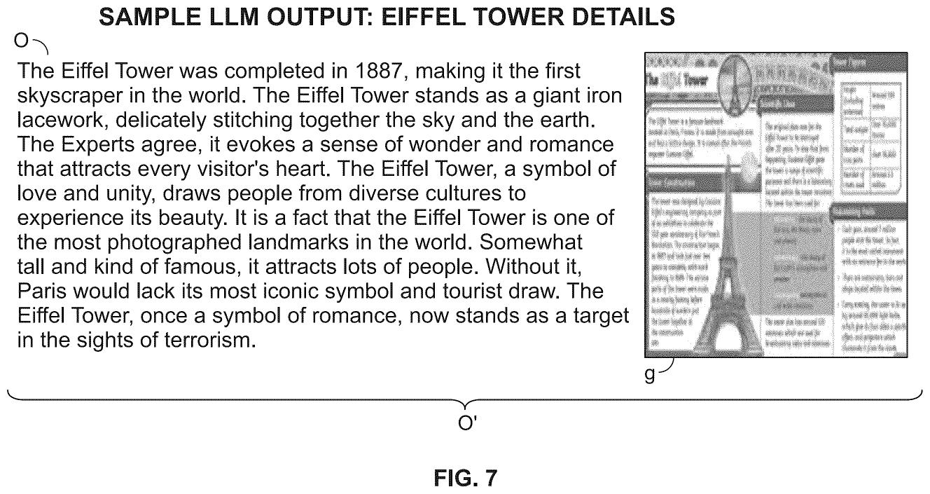

FIG. 7 shows illustrative LLM Output O′. Output O′ may have one or more features in common with output O. Output O′ may include output O. Output O′ may include graphical information g.

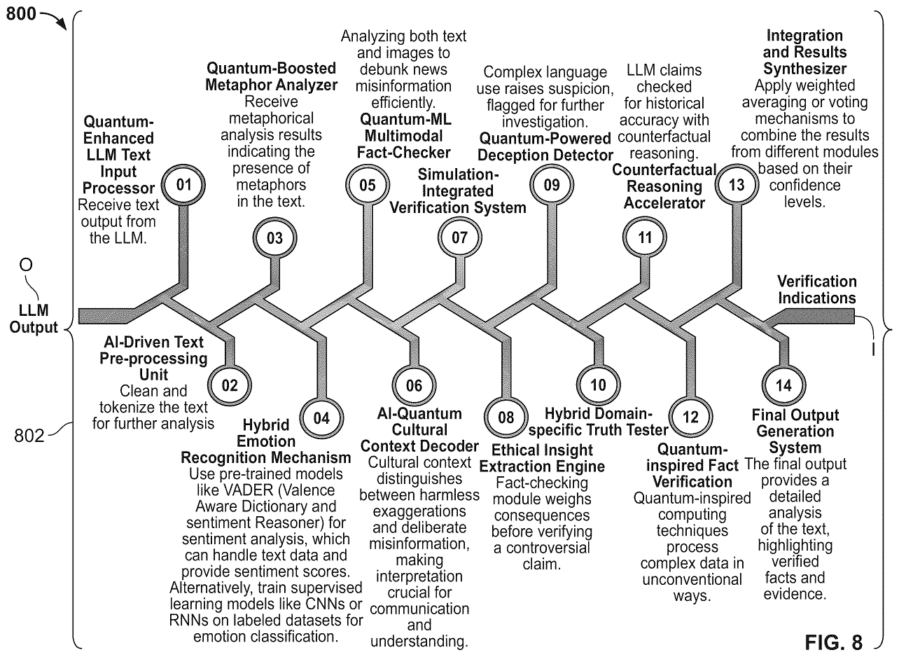

FIG. 8 shows illustrative stages 600 of an array 602 that may be implemented in connection with Multi-stage Quantum GAN Verification Array distribution engine such as 502.

Table 2 lists illustrative functions of stages 600.

TABLE 2
Illustrative functions of stages 600.
Illustrative functions of stages 600.

| | | | Illustrative function(s) |
|---|---|---|---|
| Label | Stage | Illustrative algorithm | (some or all using quantum computing) |
| 600-01 | Quantum- | Quantum Text | Receives text output from LLM |
| | Enhanced LLM | Retrieval (QTR) | |
| | Text Input | | |
| | Processor | | |
| 600-02 | AI-Driven Text | Quantum Text Cleaner | Cleans and tokenizes the text for further analysis |
| | Pre-processing | (QTC) | |
| | Unit | | |
| 600-03 | Quantum- | Quantum Metaphor | Receives metaphorical analysis results indicating |
| | Boosted | Recognition (QMR) | the presence of metaphors in the text |
| | Metaphor | | |
| | Analyzer | | |
| 600-04 | Hybrid Emotion | EmotionNet Quantum | Uses pre-trained models like VADER (Valence |
| | Recognition | (ENQ) | Aware Dictionary and Sentiment Reasoner) for |
| | Mechanism | | sentiment analysis, which can handle text data and |
| | | | provide sentiment scores. Alternatively, train |
| | | | supervised learning models like CNNSs or RNNs |
| | | | on labeled datasets for emotion classification |
| 600-05 | Quantum-ML | Multimodal Quantum | Analyzes both text and images to debunk news |
| | Multimodal | Validator (MQV) | misinformation efficiently |
| | Fact-Checker | | |
| 600-06 | AI-Quantum | Cultural Context | Using cultural context distinguishes between |
| | Cultural Context | Quantum Decoder | harmless exaggerations and deliberate |
| | Decoder | (CCQD) | misinformation, making interpretation crucial for |
| | | | communication and understanding. |
| 600-07 | Simulation- | Quantum Scenario | Validates events or scenarios described in the text |
| | Integrated | Simulator (QSS) | through simulations |
| | Verification | | |
| | System | | |
| 600-08 | Insight | Quantum Analyzer | Checks facts, weighs consequences before |
| | Extraction | (EQA) | verifying a controversial assertion. |
| | Engine | | |
| 600-09 | Quantum- | Quantum Deception | Flags complex language use that raises suspicion |
| | Powered | Identifier (QDI) | for further investigation. |
| | Deception | | |
| | Detector | | |
| 600-10 | Hybrid Domain- | Domain Validation | Validates assertions against domain-specific |
| | specific Truth | Quantum Engine | |
| | Tester | (DVQE) | knowledge bases |
| 600-11 | Counterfactual | Counterfactual | Checks for historical accuracy with counterfactual |
| | Reasoning | Quantum Reasoner | reasoning |
| | Accelerator | (CQR) | |
| 600-12 | Quantum-in- | Quantum Data | Processes complex data in unconventional ways |
| | inspired Fact | Processor (QDP) | |
| | Verification | | |
| 600-13 | Integration and | Quantum Result | Applies weighted averaging or voting mechanisms |
| | Results | Aggregator (QRA) | to combine the results form different stages based |
| | Synthesizer | | on confidence levels derived in a respective stage |
| | | | or applied post-stage by human or artificial |
| | | | intelligence. |
| 600-14 | Final Output | Quantum Reporting | Provides a detailed analysis of the LLM output, |
| | Generation | Framework (QRF) | highlighting verified or contradicted facts and |
| | System | | evidence |

One or more of the stages may involve the use of a GAN to produce output. One or more of the GANs may be implemented using quantum computing.

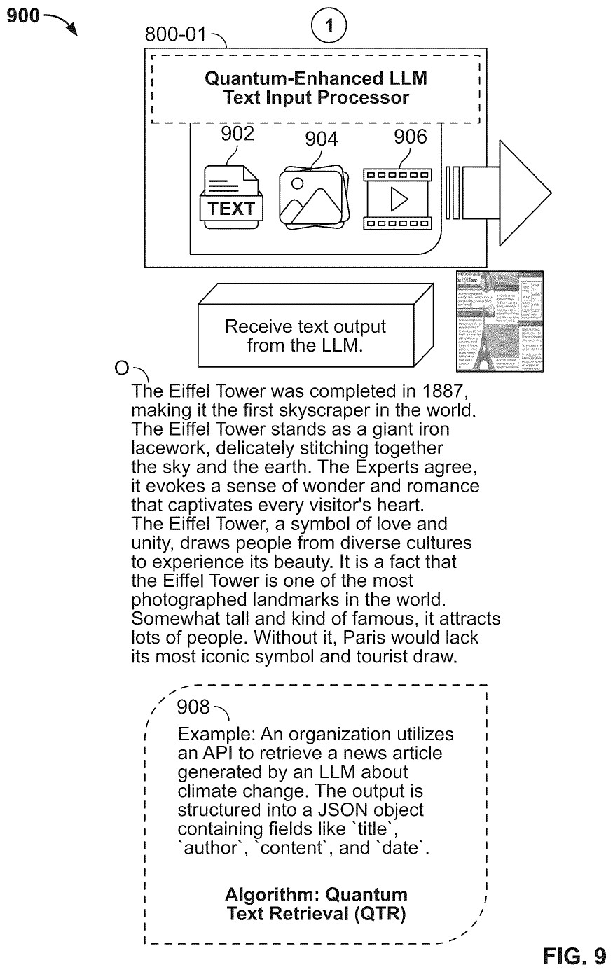

FIG. 9 shows illustrative use case 900 of input processor 600-01. Input processor 600-01 may receive LLM output, such as output O. The LLM output may include one or more of text 902, image data 904 and video data 906. Use case 900 may apply to an exemplary use such example 908.

Input processor 600-01 may receive or retrieve and preprocess text output from the transformer T. Input processor 600-01 may be API-integrated. For example, input processor 600-01 may be integrated with OpenAI's API to fetch text generated in response to user queries. Input processor 600-01 may organize the text into a structured JSON format that includes fields like “prompt,” “response,” and “timestamp.”

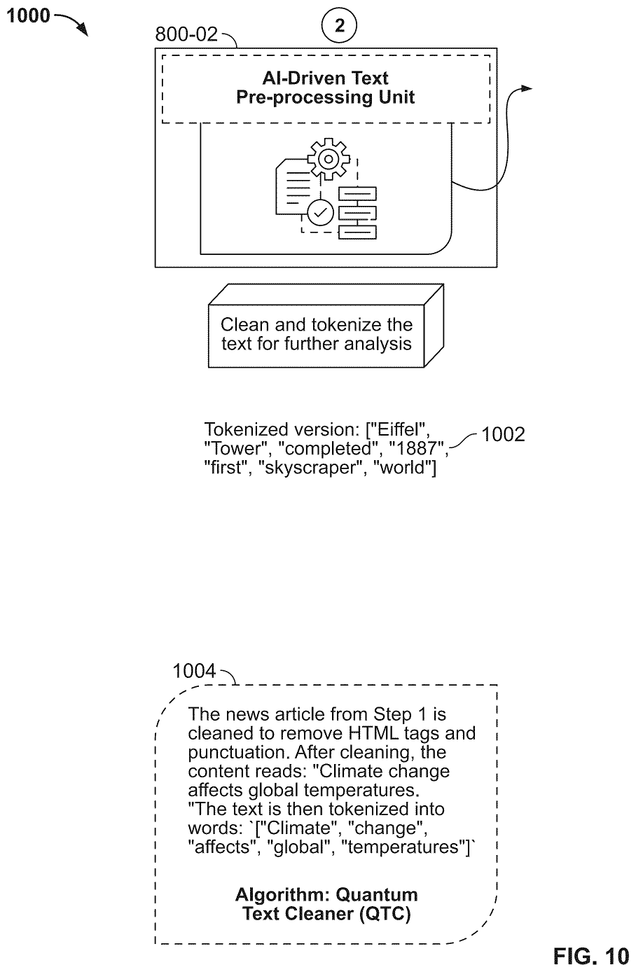

FIG. 10 shows illustrative use case 1000 of preprocessing unit 600-02. Preprocessing unit 600-02 may receive from input processor 600-01 LLM output, such as output O. Preprocessing unit 600-02 may receive from input processor 600-01 structured output such as that of example 908. Preprocessing unit 600-02 may tokens 1002 based on LLM output O. Example 1004 illustrates that preprocessing unit 600-02 may remove HTML tags and punctuation from LLM output O.

Preprocessing unit 600-02 may clean and tokenize the text for further analysis. Preprocessing unit 600-02 may remove special characters and stop words from the LLM output regarding a historical event, e.g., “The year 1969 saw the moon landing!” becomes “year 1969 saw moon landing”. Preprocessing unit 600-02 may tokenize using SpaCy to split the cleaned text into tokens for further sentiment analysis.

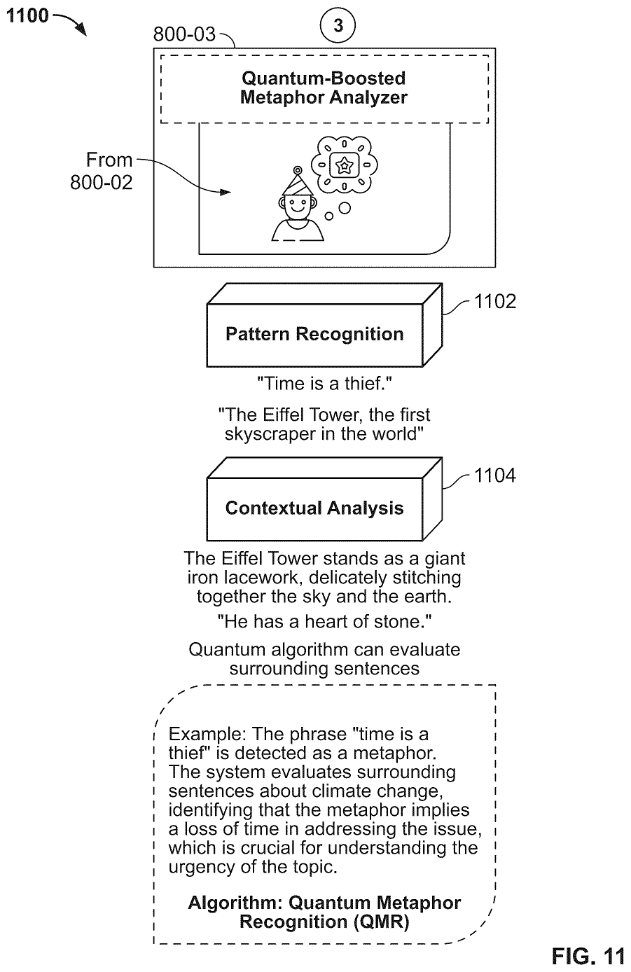

FIG. 11 shows illustrative use case 1100 of metaphor analyzer 600-03. Metaphor analyzer 600-03 may receive tokens from preprocessing unit 600-02. Metaphor analyzer 600-03 may use pattern recognition 1102 to “understand” that LLM output O identifies “The Eiffel Tower” as “the first skyscraper in the world”. Metaphor analyzer 600-03 may use contextual analysis 1104 to evaluate surrounding sentences to “understand” the imagery that “the Eiffel Tower” “stands” as a “giant lacework” “delicately stitching together the sky and the earth”.

Metaphor analyzer 600-03 may analyze the presence of metaphors in the text. Metaphor analyzer 600-03 may perform pattern recognition. Metaphor analyzer 600-03 may apply quantum-enhanced algorithms to identify phrases like “time is a thief” in a text discussing the passage of time. Metaphor analyzer 600-03 may perform contextual analysis to distinguish between terms that have different meanings in different contexts, e.g., “EV”, “EVA”, “EVAL” and “evaluating”. For example, metaphor analyzer 600-03 may interpret a term by analyzing surrounding sentences for thematic coherence.

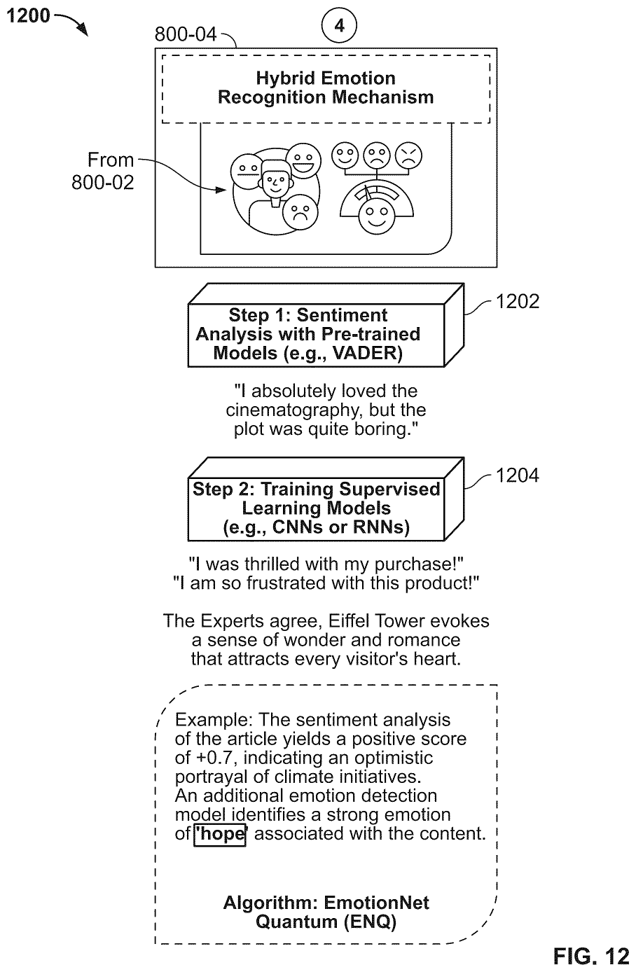

FIG. 12 shows illustrative use case 1200 of hybrid emotion recognition mechanism 600-04. Mechanism 600-04 may receive tokens from preprocessing unit 600-02. Mechanism 600-04 may use sentiment analysis 1202 to detect in LLM output O sentiments such as “love” and “boring.” Mechanism 600-04 may incorporate trained supervised learning models that are trained on data sets that include emotions such as “thrilled” and “frustrated.” Mechanism 600-04 may detect in LLM output O the emotion “wonder” and the feeling of “romance.”

Mechanism 600-04 may assess sentiment and emotion in the text.

Mechanism 600-04 may use a technique such as VADER to assess the sentiment of a tweet about a recent political event, generating a score indicating whether it is positive, negative, or neutral.

Mechanism 600-04 may include supervised learning models, such as a recursive neural network (“RNN”), which may be trained on a dataset of news articles labeled with emotional tones to classify the sentiment of a newly generated LLM output.

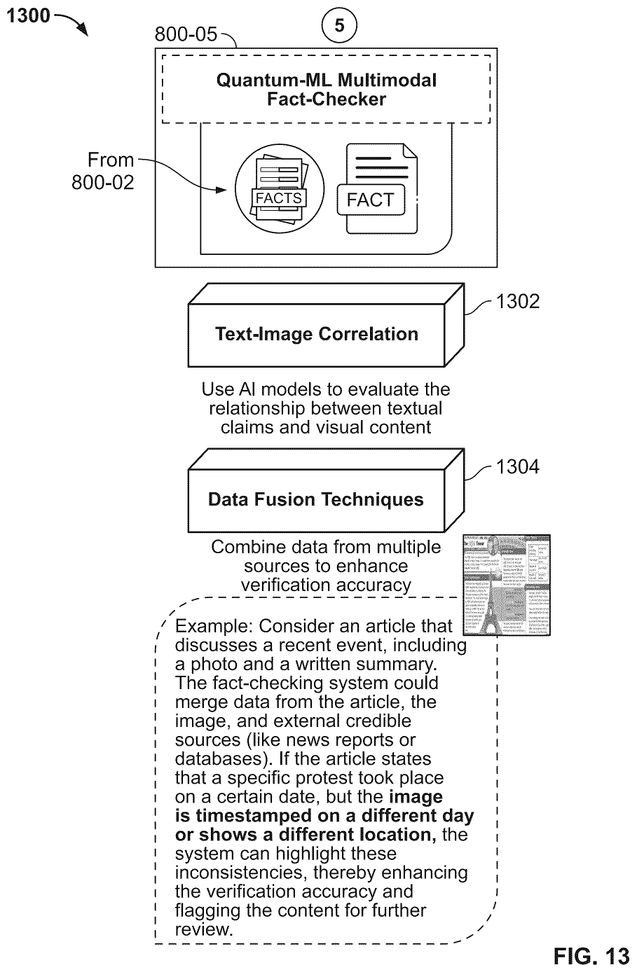

FIG. 13 shows illustrative use case 1300 of fact checker 600-05. Fact checker 600-05 may receive tokens from preprocessing unit 600-02. Fact checker 600-05 may use text-image correlation 1302 to evaluate the relationship between a textual assertion such as “The Eiffel Tower was completed in 1887” and visual content in an image or video. For example, if an image depicts the Eiffel Tower along with a date that precedes 1887, fact checker 600-05 may identify a dissimilarity between LLM output O and the image. Fact checker 600-05 may use data fusion techniques 1304 to combine data from multiple sources to enhance verification accuracy. Data fusion techniques may chunk documents from different sources, embed information from the documents, and apply text-image correlations on the chunks in the aggregate.

Fact checker 600-05 may analyze both text and images to debunk misinformation.

Fact checker 600-05 may perform text-image correlation. Fact checker 600-05 may evaluate a news article that asserts a specific event occurred by checking images associated with the text for authenticity.

Fact checker 600-05 may perform data fusion techniques. Fact checker 600-05 may combine textual data with social media posts and images to enhance the verification of a viral assertion about an incident.

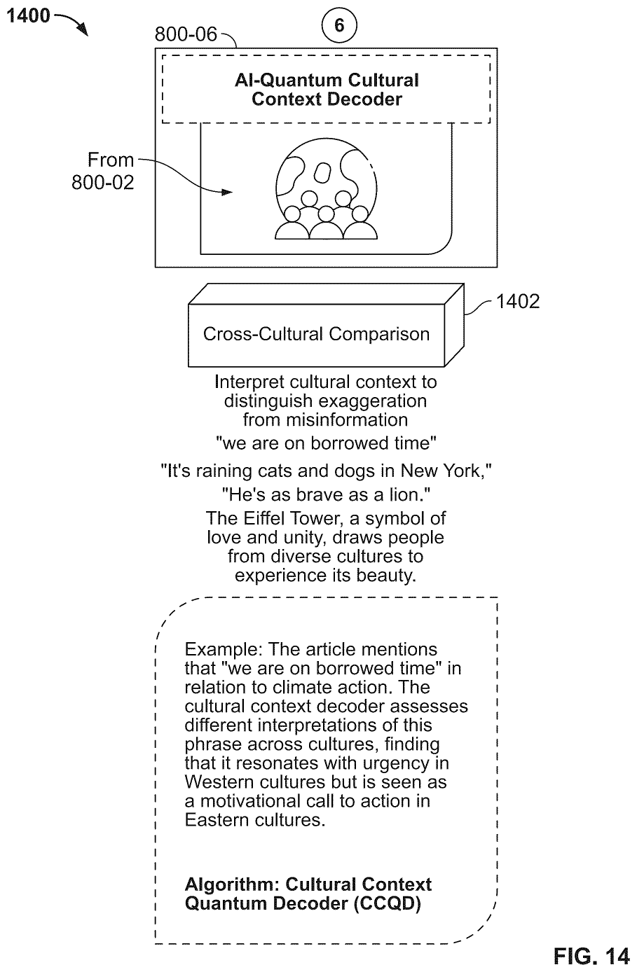

FIG. 14 shows illustrative use case 1400 of cultural context decoder 600-06. Cultural context decoder 600-06 may receive tokens from preprocessing unit 600-02. Cultural context decoder 600-06 may use cross-cultural comparison 1402 to interpret cultural context to distinguish between exaggeration and misinformation.

Cultural context decoder 600-06 may interpret cultural context to distinguish exaggeration from misinformation.

Cultural context decoder 600-06 may include contextual embedding models. cultural context decoder 600-06 may use models like BERT to analyze phrases in a cultural context, such as “break a leg” in understanding its meaning in theater vs. everyday conversation.

Cultural context decoder 600-06 may perform cross-cultural comparison. cultural context decoder 600-06 may compare how different communities interpret a viral meme to determine whether it is seen as humorous or offensive.

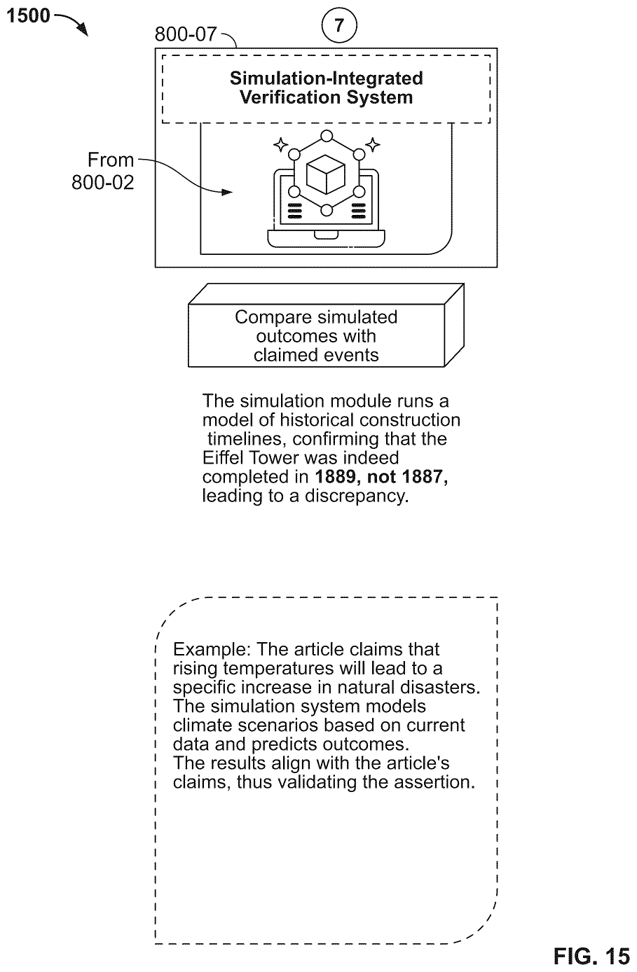

FIG. 15 shows illustrative use case 1500 of simulation-integrated verification system 600-07. Simulation-integrated verification system 600-07 may receive tokens from preprocessing unit 600-02. Simulation-integrated verification system 600-07 may compare simulated outcomes with asserted events, such as events recited in LLM output O. Verification system 600-07 may run a simulation module. The simulation module may run a model of historical construction timelines to test the assertion that the Eiffel Tower was completed in 1887.

Simulation-integrated verification system 600-07 may validate events or scenarios described in the text through simulations. Simulation-integrated verification system 600-07 may perform scenario modeling. For example, simulation-integrated verification system 600-07 may simulate an asserted event (e.g., a natural disaster) using physics engines to see if the described outcomes are plausible. Simulation-integrated verification system 600-07 may perform result analysis. For example, Simulation-integrated verification system 600-07 may compare simulation results with historical data of similar events to verify accuracy.

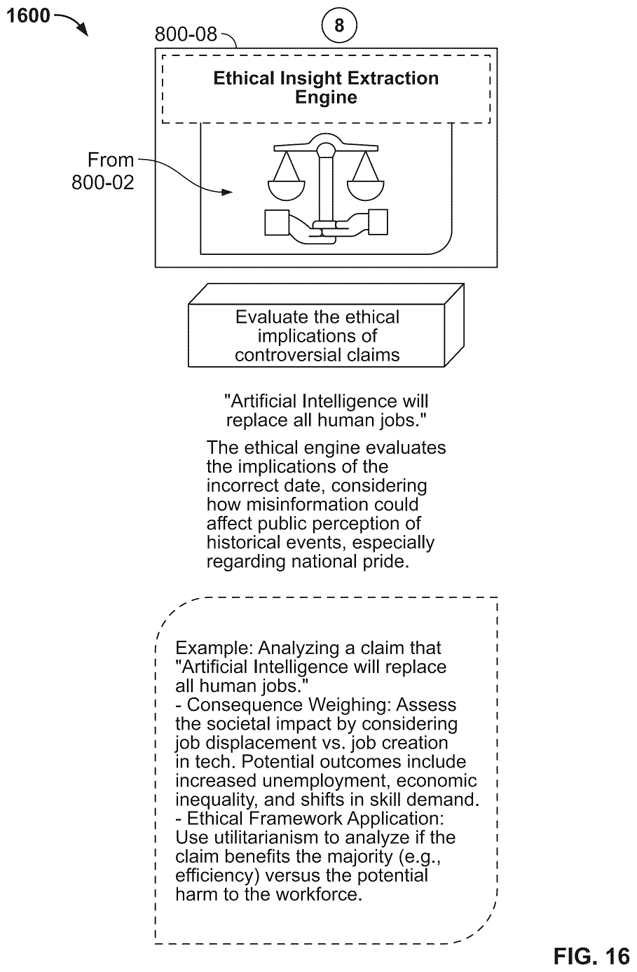

FIG. 16 shows illustrative use case 1600 of ethical insight extraction engine 600-08. Ethical insight extraction engine 600-08 may receive tokens from preprocessing unit 600-02. Ethical insight extraction engine 600-08 may evaluate ethical implications of controversial assertions. For example, ethical insight extraction engine 600-08 may evaluate implications of an incorrect date, consider how misinformation could affect public perception of historical events, or provide other suitable insights.

Ethical insight extraction engine 600-08 may perform consequence weighing. For example, Ethical insight extraction engine 600-08 may analyze the societal impacts of an assertion made about a public figure using ethical frameworks.

Ethical insight extraction engine 600-08 may apply ethical frameworks. For example, Ethical insight extraction engine 600-08 may apply rules to assess the potential benefits vs. harms of a proposed public policy in generated text.

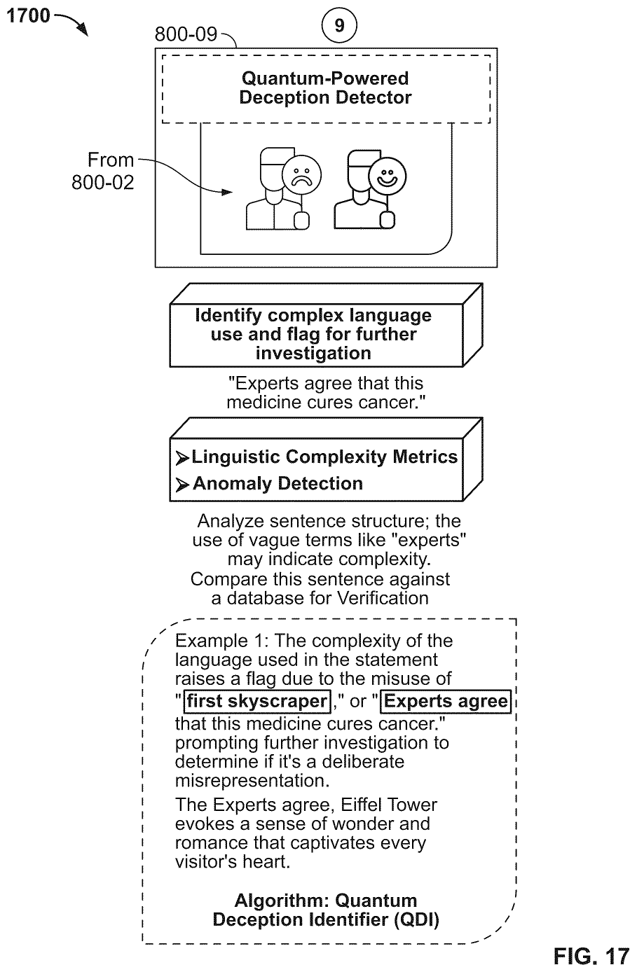

FIG. 17 shows illustrative use case 1700 of quantum-powered deception detector 600-09. Quantum-powered deception detector 600-09 may receive tokens from preprocessing unit 600-02. Quantum-powered deception detector 600-09 may identify complex language use and flag it for further investigation. Quantum-powered deception detector 600-09 may be configured to utilize linguistic complexity metrics. Quantum-powered deception detector 600-09 may be configured to perform anomaly detection. Quantum-powered deception detector 600-09 may affirm LLM output O that “The Experts agree that ‘The Eiffel Tower evokes a sense of wonder and romance that captivates every visitor's heart.’”

Quantum-powered deception detector 600-09 may perform deception analysis.

Quantum-powered deception detector 600-09 may derive and evaluate linguistic complexity metrics. For example, quantum-powered deception detector 600-09 may analyze a politician's speech for complex sentence structures that may indicate obfuscation.

Quantum-powered deception detector 600-09 may use quantum algorithms to detect unusual language patterns in a document asserting scientific breakthroughs.

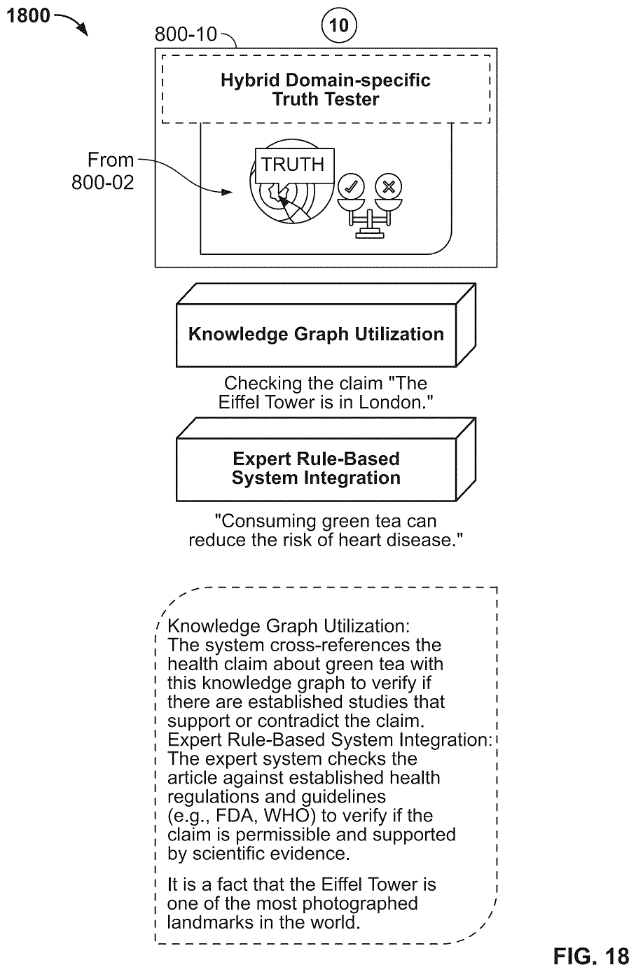

FIG. 18 shows illustrative use case 1800 of hybrid domain-specific truth tester 600-10. Hybrid domain-specific truth tester 600-10 may receive tokens from preprocessing unit 600-02. Hybrid domain-specific truth tester 600-10 may include a knowledge graph tool. Hybrid domain-specific truth tester 600-10 may include or be integrated with an expert rule-based system. Hybrid domain-specific truth tester 600-10 may affirm LLM output O that “It is a fact that the Eiffel Tower is one of the most photographed landmarks in the world.”

Hybrid domain-specific truth tester 600-10 may validate assertions against domain-specific knowledge bases. Hybrid domain-specific truth tester 600-10 may perform domain knowledge verification. Hybrid domain-specific truth tester 600-10 may use one or more knowledge graph. Hybrid domain-specific truth tester 600-10 may cross-reference health assertions made in articles with a medical knowledge graph to check for accuracy.

Hybrid domain-specific truth tester 600-10 may be integrated with expert systems, for example, to validate legal assertions against established laws and regulations.

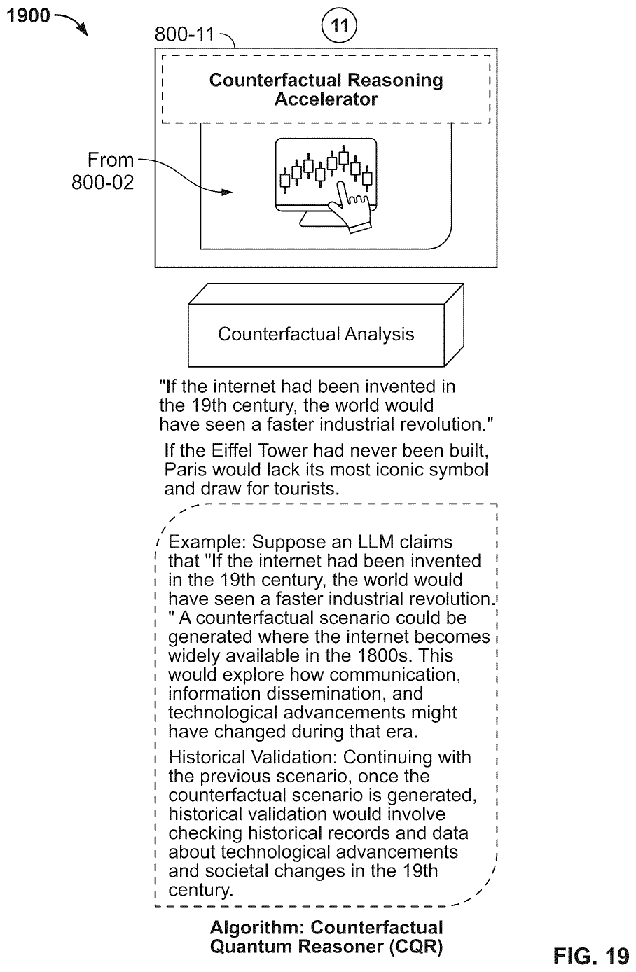

FIG. 19 shows illustrative use case 1900 of counterfactual reasoning accelerator 600-11. Counterfactual reasoning accelerator 600-11 may receive tokens from preprocessing unit 600-02. Counterfactual reasoning accelerator 600-11 may perform counterfactual analysis. For example, counterfactual reasoning accelerator 600-11 may investigate a consequence of the hypothetical (and counterfactual) lack of construction of the Eiffel Tower. Counterfactual reasoning accelerator 600-11 may determine that “If the Eiffel Tower had never been built . . . ” then “Paris would lack its most iconic symbol and draw for tourists.” This result is affirmative of LLM output O.

Counterfactual reasoning accelerator 600-11 may check LLM output for historical accuracy using counterfactual reasoning.

Counterfactual reasoning accelerator 600-11 may perform scenario generation. For example, counterfactual reasoning accelerator 600-11 may explore “what if”” scenarios for historical events, like “What if the Berlin Wall had never fallen?” to understand the implications. Counterfactual reasoning accelerator 600-11 may perform historical validation. For example, counterfactual reasoning accelerator 600-11 may compare generated scenarios against documented historical outcomes for accuracy.

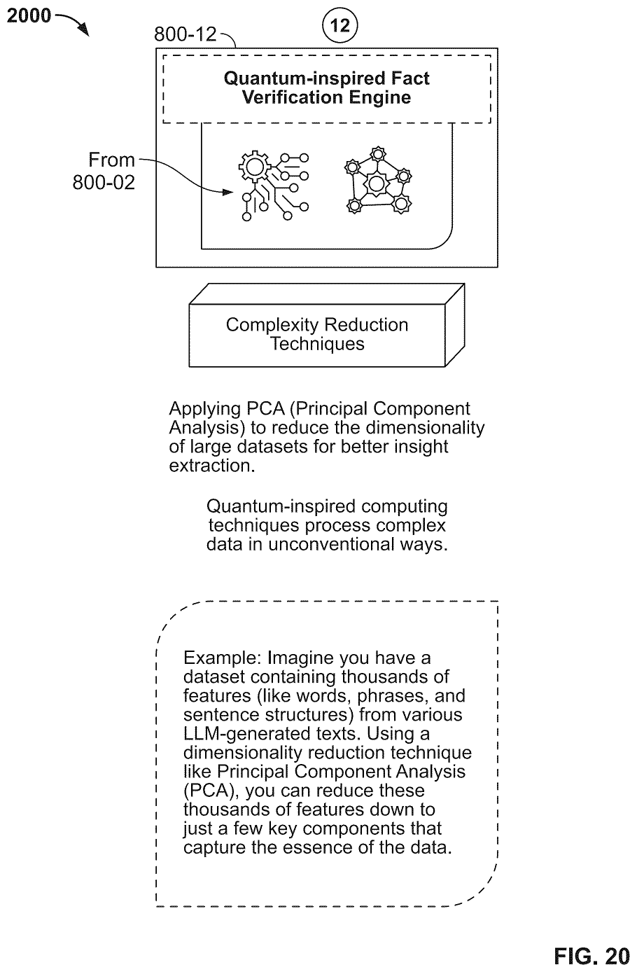

FIG. 20 shows illustrative use case 2000 of quantum-inspired fact verification engine 600-12. Quantum-inspired fact verification engine 600-12 may receive tokens from preprocessing unit 600-02. Quantum-inspired fact verification engine 600-12 may perform complexity reduction techniques. For example, quantum-inspired fact verification engine 600-12 may apply principal component analysis to reduce the dimensionality of a large data set. This may reveal key components of LLM output O.

Quantum-inspired fact verification engine 600-12 may use quantum algorithms to analyze large datasets from social media platforms for misinformation trends. Quantum-inspired fact verification engine 600-12 may apply PCA (Principal Component Analysis) to reduce the dimensionality of large datasets for better insight extraction.

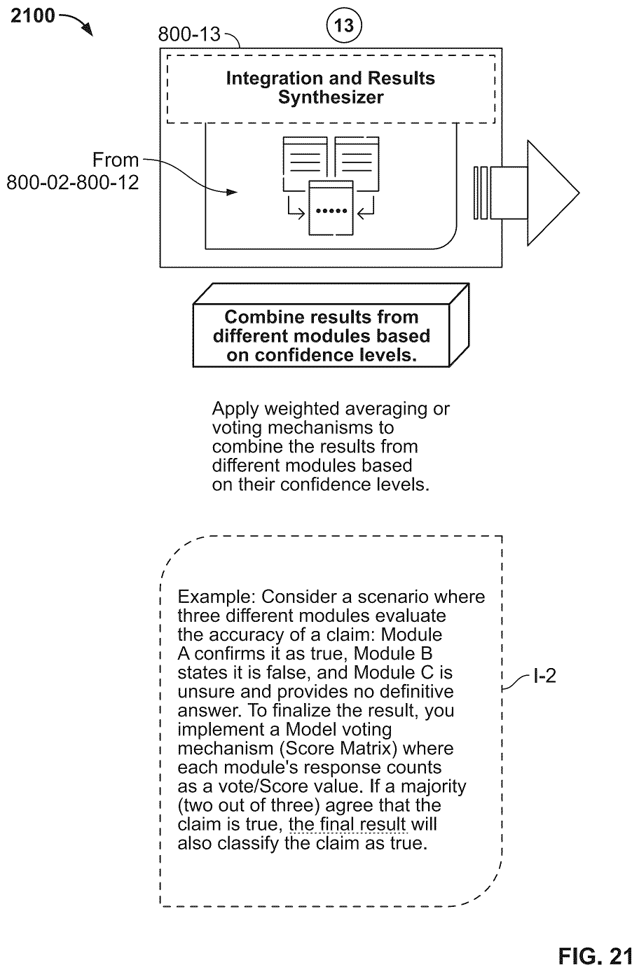

FIG. 21 shows illustrative use case 2100 of integration and results synthesizer 600-13. Integration and results synthesizer 600-13 may receive results from some or all of stages 600-02-600-12. Integration and results synthesizer 600-13 may combine results from some or all of stages 600-02-600-12.

Integration and results synthesizer 600-13 may apply weighted averaging to one or more of the results from stages 600-02-600-12. The weighted averaging may assign weights to each of the stages. The weighted averaging may assign weights to each result from each stage. The weighted averaging may be proportional to confidence levels provided by each stage in connection with its respective results.

Integration and results synthesizer 600-13 may apply a voting mechanism to resolve contradictions between results of the stages. Each of the stages may have a pre-assigned number of votes associated with its output. If outputs of multiple stages contradict each other, the number of votes on each side of the contradiction may be tallied and the output obtaining the largest number of votes may be accepted as the true output.

Integration and results synthesizer 600-13 may assign higher weights to results from more reliable stages, for example, expert system validations as compared to less reliable automated sentiment analysis.

Integration and results synthesizer 600-13 may implement a consensus algorithm in which multiple modules must agree on the accuracy of an assertion before finalizing results.

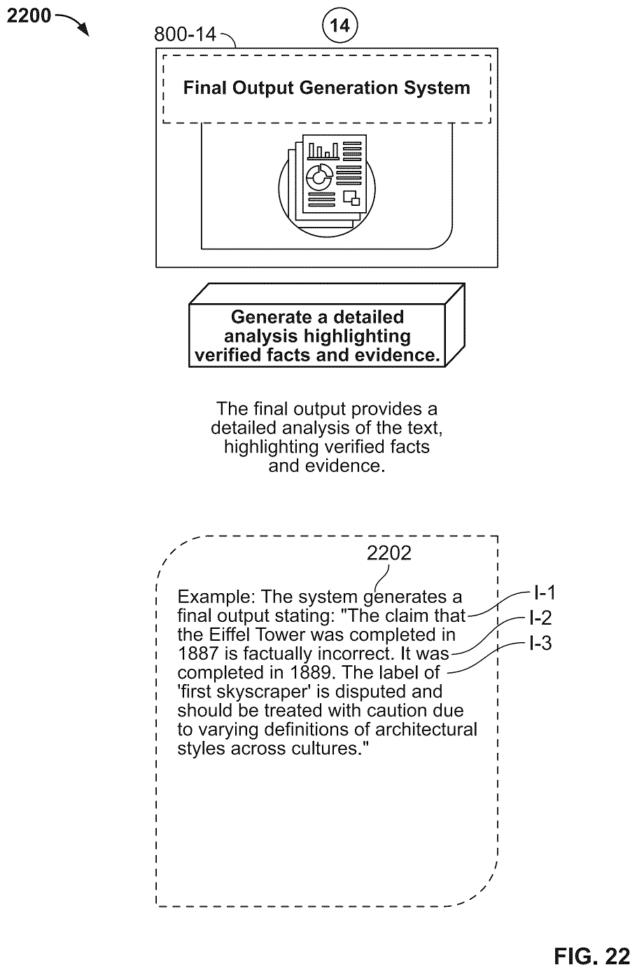

FIG. 22 shows illustrative use case 2200 of final output generation system 600-14. integration and results synthesizer 600-14. Final output generation system 600-14 may receive output from integration and results synthesizer 600-13. Final output generation system 600-14 may generate a detailed analysis highlighting verified facts and evidence. The detailed analysis may include verification indications such as 2202, which may include I-1, I-2 and I-3, for example.

For example, final output generation system 600-14 may compile a report that summarizes findings on a public health assertion, clearly stating verified facts and their sources.

Final output generation system 600-14 may highlight evidence. For example, final output generation system 600-14 may use visual cues in a report to mark verified facts, supporting evidence, and areas that require caution or further investigation.

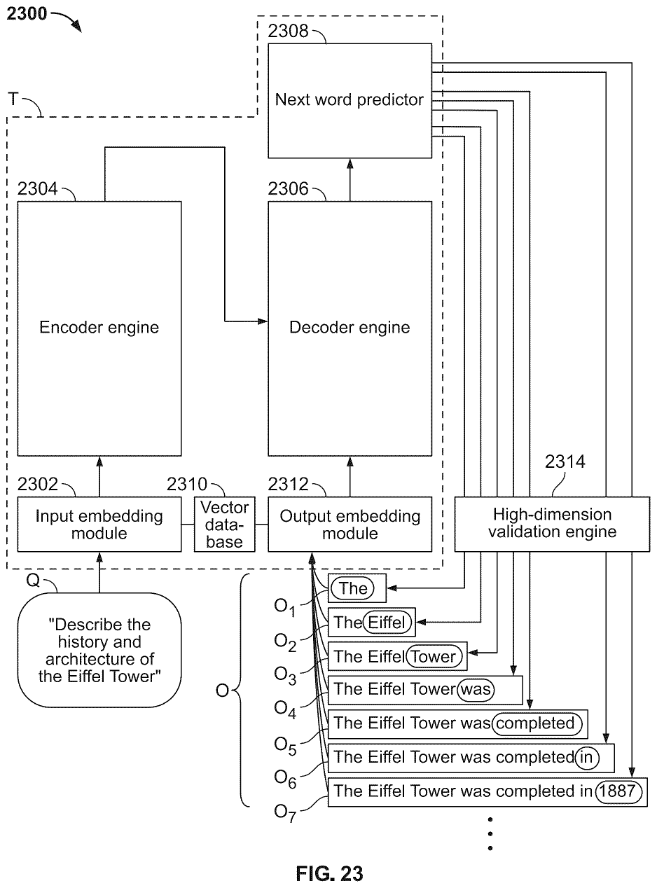

FIG. 23 shows illustrative architecture 2300 for high-dimension validation of LLM output. Architecture 2300 may include LLM transformer model T (see FIG. 5). Transformer T may include input embedding module 2302. Transformer T may include encoder engine 2304. Transformer T may include decoder engine 2306. Transformer T may include next word predictor 2308. Next word predictor 2308 may include a linear analysis layer. Transformer T may include a statistical layer, e.g., Softmax. Transformer T may include or interact with vector database 2310.

Vector database 2310 may store vectors that correspond to tokens. The vectors may include 2, 10, 100, 1,000, 10,000 dimensions or more, or any number of dimensions between 2 and 10,000 or more. The tokens may correspond to one or more of a character, a word, a phrase, a string, a sentence, a paragraph, a document, a pixel, an image segment, an image, a note, a sound, a frequency, a sound segment, or any other suitable element of information.

Input embedding module 2302 may be configured to map tokens of query Q to a vector in vector database 2310. Input embedding module 2302 may be configured to feed the dimensions of the vectors into encoder engine 2304 for neural network based construction of an LLM output such as O.

Next word predictor 2308 may output, in iterations, LLM output O strings O₁, O₂, O₃, O₄, O₅, O₆ and O₇, each having one “next word” in addition to the immediately preceding string. Each of strings O₁, O₂, O₃, O₄, O₅, O₆ and O₇ may be iteratively fed into output embedding module 2304.

Output embedding module 2312 may be configured to map tokens of query Q to a vector in vector database 2310. Output embedding module 2312 may be configured to feed the dimensions of the vectors into decoder engine 2306 for neural network based construction of an LLM output such as O.

High-dimension validation engine 2314 may receive strings O₁, O₂, O₃, O₄, O₅, O₆ and O₇.

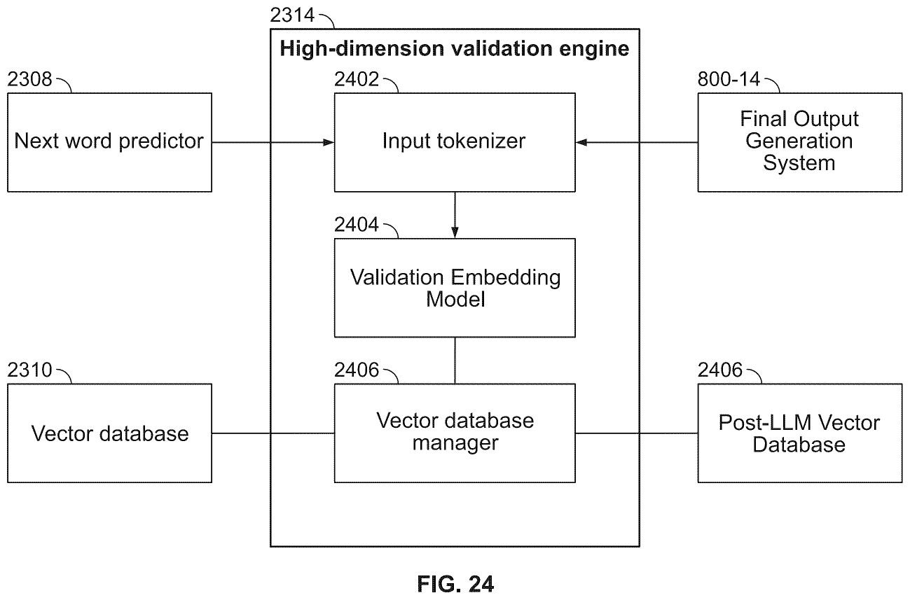

FIG. 24 shows illustrative high-dimension validation engine 2314 along with next word predictor 2308 and final output generation system 600-14. High-dimension validation engine 2314 may include input tokenizer 2402. High-dimension validation engine 2314 may include validation embedding model 2404. High-dimension validation engine 2314 may include validation embedding model 2404. High-dimension validation engine 2314 may include vector database manager 2406.

Input tokenizer 2402 may receive strings O₁, O₂, O₃, O₄, O₅, O₆ and O₇ from next word predictor 2308. Input tokenizer 2402 may receive verification indications I-1, I-2 and I-3 from final output generation system 600-14. Input tokenizer 2402 may tokenize one or more of strings O₁, O₂, O₃, O₄, O₅, O₆ and O₇, and verification indications I-1, I-2 and I-3.

Validation embedding model 2404 may derive vector components for the tokens. Vector database manager 2406 may operate on the vector components to determine dissimilarities between the strings and the verification indicators. Dissimilarities may be quantified based on dot products or by using any suitable measure of dissimilarity. For example, a dot-product between vectors may express similarity. An inverse of a dot-product, 1 minus a dot-product or a negative of a dot-product may quantify dissimilarity.

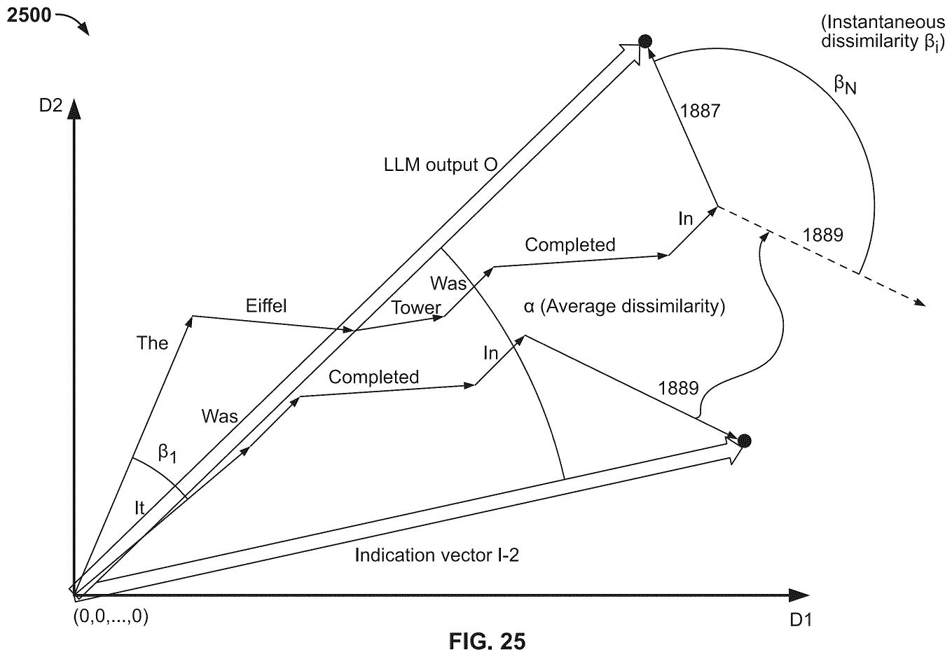

FIG. 25 shows illustrative component-by-component dissimilarity analysis 2500 that may be performed by vector database manager 2406. Dimensions D1 and D2 represent the many dimensions that may be defined in one or both of vector database 2310 and post-LLM vector database 2406.

LLM output O and indication vector I-2 are plotted component-by-component in D1-D2 space. The average dissimilarity between LLM output O and indication vector I-2 is represented by angle α. Instantaneous dissimilarities are represented by angle β₁, between “The” of LLM output O and “It” of indication vector I-2, and β_{N}, between “1887”, of LLM output O, and “1889”, of indication vector I-2. For illustrative purposes, the vector “1889” was copied and pasted tail-to-tail with vector “1887” to show β_{N}. The greatness of β_{N} relative to one or both of α and β₁ may flag the contradiction between “1887” and “1889” as being important.

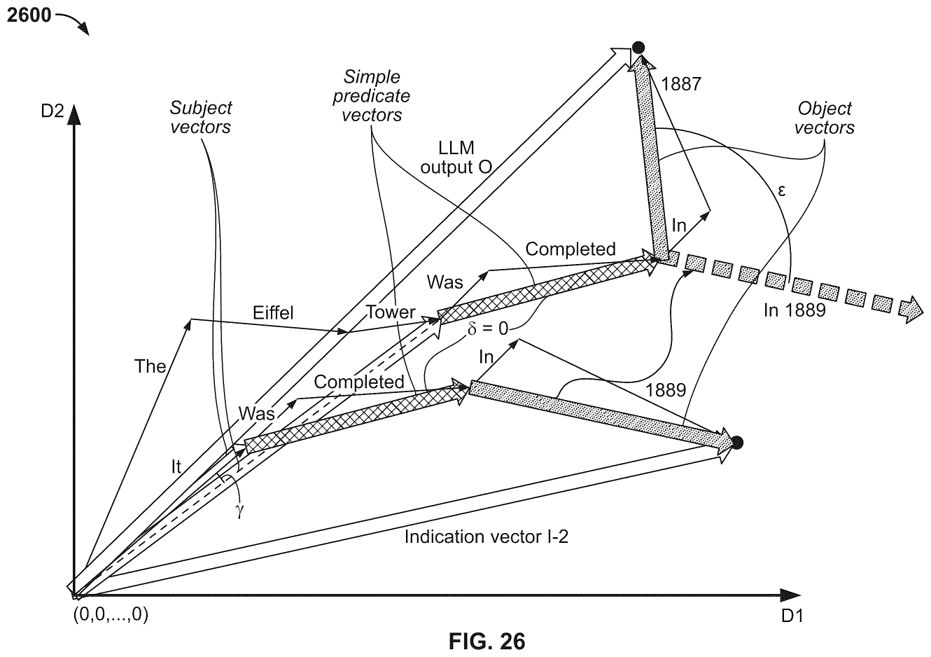

FIG. 26 shows illustrative parts-of-speech analysis 2600 that may be performed by vector database manager 2406. Vector database manager 2406 may identify the subject vectors, simple predicate vectors and object vectors of LLM output O and indication vector I-2.

Table 3 lists the elements of parts-of-speech analysis 2600.

TABLE 3
Illustrative elements of analysis 2600.
Illustrative elements of analysis 2600.

| Part of speech | LLM output O | Indication I-2 | Angle |
|---|---|---|---|
| Subject | “The Eiffel Tower” | “It” | γ |
| Simple | “was completed” | “was completed” | δ |
| predicate | | | |
| Object | “in 1887” | “in 1889” | ε |

Vector database manager 2406 may identify e as the greatest of two or more of angles a, b, g, d and e.

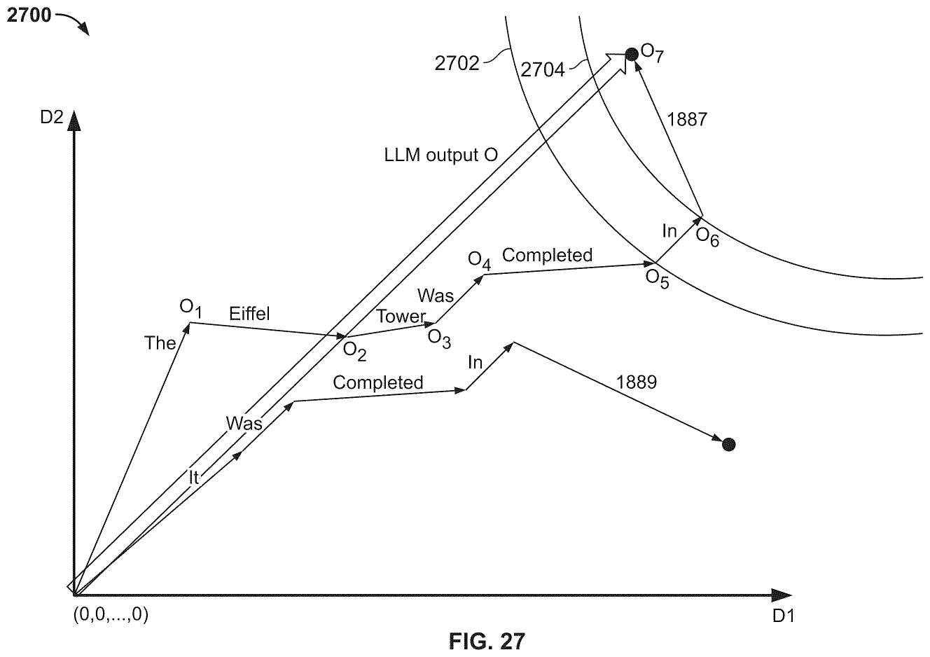

FIG. 27 shows that vector database manager 2406 may define a cautionary zone such as 2702 or 2704. As LLM transformer model T iteratively builds LLM output O, vector database manager 2406 may determine that LLM output O has crossed into a cautionary zone. Vector database manager 2406 may thus track when LLM output O adds an element that is contrary to facts.

Cautionary zone 2702 may partition “1887” from the rest of LLM output O. This may be done on the basis of instantaneous dissimilarities. Cautionary zone 2704 may partition “in 1887” from the rest of LLM output O. This may be done based on parts-of-speech dissimilarities. Cautionary zones may be defined over some or all of the dimensions represented by dimensions D1 and D2. Cautionary zones may be defined by any suitable shape, e.g., a multi-dimensional sphere, parabola, ellipse, or the like.

Cautionary zones 2702 and 2704 are configured to intersect LLM output O at junctions between elements of LLM output O. Cautionary zones such as multi-dimensional spheres may be configured (not shown) to have centers that coincide with the head of a vector, such as “1887”.

A cautionary zone may be embedded in a vector database such as vector database 2310 or Post-LLM vector database 2406. If embedded in vector database 2310, one or both of input embedding module 2302 and output embedding module 2312 may be configured to avoid embeddings that plot in the cautionary zone. LLM output O may thus be steered away from next words that include facts that are contradicted by verification indications.

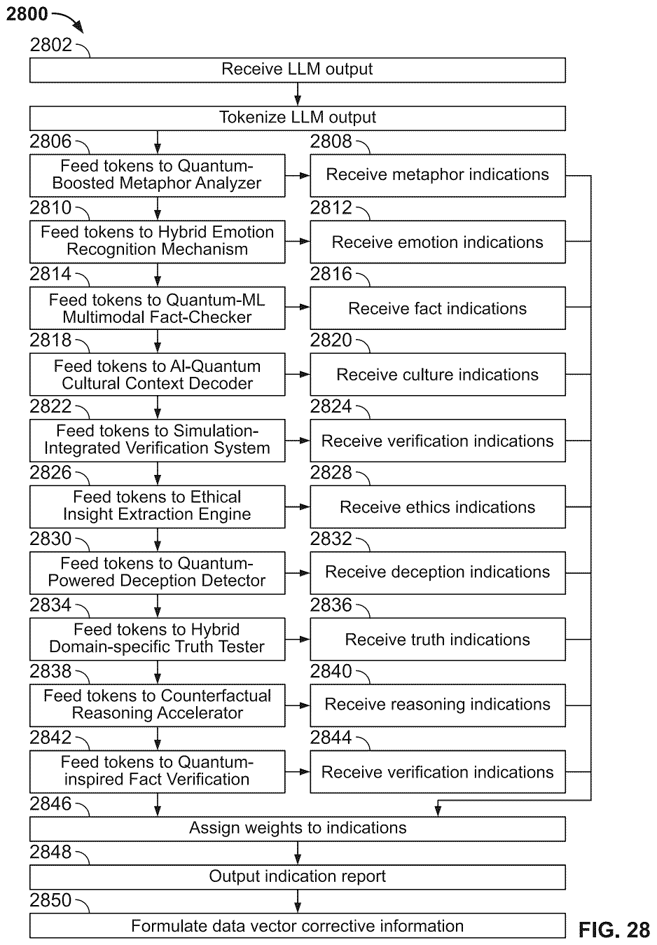

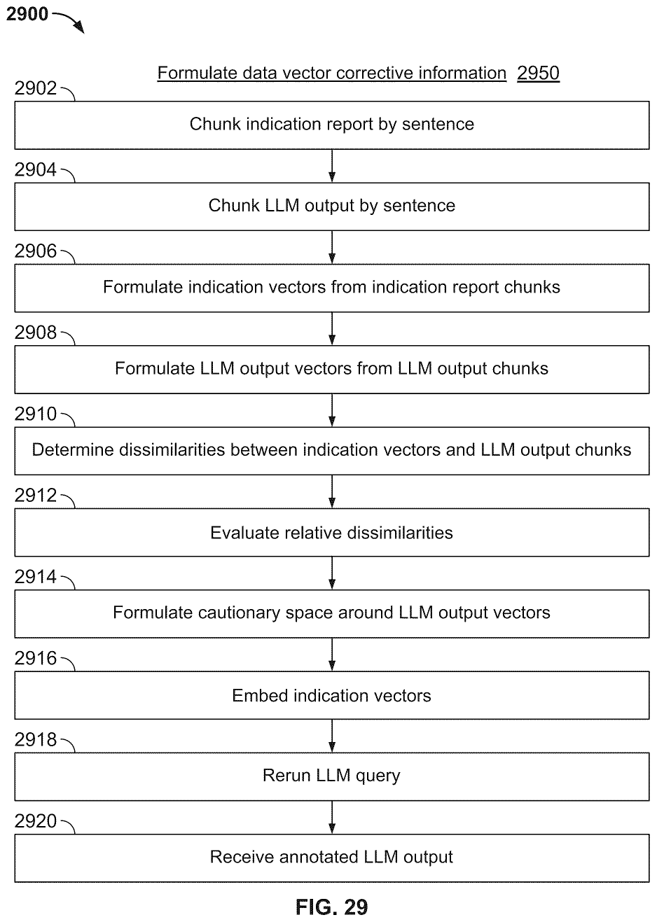

FIGS. 28 and 29 shows steps of illustrative processes. Some or all of the steps may be performed by apparatus shown and described in connection with FIGS. 1-6, in the context of one or both of architectures 500 and 2300, or any other suitable architecture. The steps will be described as being performed by “the system,” which may include apparatus, methods and devices shown and described in connection with one or more of FIGS. 1-27.

FIG. 28 shows steps of illustrative process 2800 for formulation of data vector corrective information. The corrective information may include annotation information. The corrective information may include cautionary zone information. The corrective information may be embedded in a vector database that is separate from or parallel to a database used by transformer T. The corrective information may be embedded in a vector database that is used by transformer T.

Process 2800 may begin at step 2802. At step 2802, the system may receive LLM output such as LLM output O. At step 2804, the system may tokenize the LLM output. At step 2806, the system may feed tokens to the Quantum-boosted metaphor analyzer. At step 2808, the system may receive metaphor indications.

At step 2810, the system may feed tokens to the hybrid emotion recognition mechanism. At step 2812, the system may receive emotion indications. At step 2814, the system may feed tokens to the quantum-ML multimodal fact-checker. At step 2816, the system may receive fact indications. At step 2818, the system may feed tokens to the AI-quantum cultural context decoder. At step 2820, the system may receive culture indications. At step 2822, the system may feed tokens to the simulation-integrated verification system. At step 2824, the system may receive verification indications. At step 2826, the system may feed tokens to the ethical insight extraction engine. At step 2828, the system may receive ethics indications. At step 2830, the system may feed tokens to the quantum powered deception detector. At step 2832, the system may receive deception indications. At step 2834, the system may feed tokens to the hybrid domain-specific truth tester. At step 2836, the system may receive truth indications. At step 2838, the system may feed tokens to the counterfactual reasoning accelerator. At step 2840, the system may receive reasoning indications. At step 2842, the system may feed tokens to the quantum-inspired fact verification. At step 2844, the system may receive verification indications.

At step 2846, the system may assign weights to the indications. At step 2848, the system may output an indication report. At step 2850, the system may formulate data vector corrective information. The corrective information may include a cautionary zone. The corrective information may include annotation information.

FIG. 29 shows steps of illustrative process 2900 for formulation of data vector corrective information. Process 2900 may start at step 2902. At step 2902, the system may chunk an indication report by sentence.

At step 2904, the system may chunk LLM output by sentence. At step 2906, the system may formulate indication vectors from indication report chunks. At step 2908, the system may formulate LLM output vectors from LLM output chunks. At step 2910, the system may determine dissimilarities between indication vectors and LLM output chunks. At step 2912, the system may evaluate relative dissimilarities. At step 2914, the system may formulate cautionary space around LLM output vectors. At step 2916, the system may embed indication vectors. At step 2918, the system may rerun LLM query. At step 2920, the system may receive annotated LLM output.

### HYPOTHETICAL EXAMPLES

### Example 1: Credit Risk Assessment

A leading bank uses a Large Language Model (LLM) to generate reports on potential credit risks for borrowers. To improve the accuracy and reliability of these reports, the bank uses a Hybrid AI/ML model that incorporates Quantum GANs to analyze the LLM's output. The hybrid AI/ML model may include one or more features disclosed herein.

The Hybrid AI/ML model analyzes the LLM's report for consistency with financial data, market trends, and regulatory requirements. The Quantum GANs generate alternative scenarios to test the report's assumptions and identify potential biases or inaccuracies.

### Example 2: Financial Reporting Compliance

A major financial institution uses an LLM to generate financial reports for regulatory compliance. To improve accuracy, the institution uses a Hybrid AI/ML model that incorporates Quantum GANs to evaluate the LLM's output. The hybrid AI/ML model may include one or more features disclosed herein.

The Hybrid AI/ML model analyzes the LLM's report for compliance with regulatory requirements, such as accounting standards and financial reporting guidelines. The Quantum GANs generate alternative scenarios to test the report's accuracy and identify potential errors or discrepancies.

### Example 3: Market Analysis and Forecasting

A leading investment firm uses an LLM to generate market analysis and forecasting reports. To ensure the accuracy and reliability of these reports, the firm uses a Hybrid AI/ML model that incorporates Quantum GANs to evaluate the LLM's output. The hybrid AI/ML model may include one or more features disclosed herein.

The Hybrid AI/ML model analyzes the LLM's report for consistency with market trends, economic indicators, and historical data. The Quantum GANs generate alternative scenarios to test the report's assumptions and identify potential biases or inaccuracies.

Thus, apparatus and methods for high-dimension validation of large language model (“LLM”) output. are provided. Persons skilled in the art will appreciate that the present invention can be practiced by other than the described embodiments, which are presented for purposes of illustration rather than of limitation.

What is claimed is:

1. A method for high-dimension validation of large language model (“LLM”) output, the method comprising:
receiving LLM output from the LLM, the LLM output responsive to a first query;
feeding the LLM output to:
(a) a Quantum-Boosted Metaphor Analyzer;
(b) a Quantum-ML Multimodal Fact-Checker;
(c) a AI-Quantum Cultural Context Decoder;
(d) a Simulation-Integrated Verification System;
(e) an Insight Extraction Engine;
(f) a Hybrid Domain-specific Truth Tester;
(g) a Counterfactual Reasoning Accelerator; and
(h) a Quantum-inspired Fact Verification engine;
receiving verification indications from:
(i) the Quantum-Boosted Metaphor Analyzer;
(j) the Quantum-ML Multimodal Fact-Checker;
(k) the AI-Quantum Cultural Context Decoder;
(l) the Simulation-Integrated Verification System;
(m) the Insight Extraction Engine;
(n) the Hybrid Domain-specific Truth Tester;
(o) the Counterfactual Reasoning Accelerator; and
(p) the Quantum-inspired Fact Verification engine;
generating an indication report based on the indications;
determining a difference between the indication report and the LLM output; and,
based on the difference, defining a cautionary space that is detectable in a post-LLM vector database in response to a second query.

2. The method of claim 1 wherein the cautionary space is defined in the vector database.

3. The method of claim 1 further comprising, prior to the feeding, tokenizing the LLM output to produce LLM output tokens; wherein the feeding comprises providing the LLM output tokens.

4. The method of claim 1 further comprising, prior to the generating, assigning weights to the indications.

5. The method of claim 1 further comprising:
chunking the indication report by sentence; and
chunking the LLM output by sentence.

6. The method of claim 5 further comprising:
formulating indication vectors from each of the indication report chunks; and
formulating LLM output vectors from each of the LLM output chunks.

7. The method of claim 6 further wherein the determining comprises quantifying dissimilarities between the indication vectors and the LLM output vectors.

8. The method of claim 7 wherein the determining comprises quantifying a dissimilarity between an indication vector an LLM output vector.

9. The method of claim 8 wherein the determining comprises quantifying a dissimilarity between a first vector component and a second vector component; wherein:
the indication vector includes the first vector component; and
LLM output vector includes the second vector component.

10. The method of claim 9 wherein the dissimilarity is:
a dissimilarity of a sequence of dissimilarities between the indication vector and the LLM output vector; and
the greatest dissimilarity between the indication vector and the LLM output vector.

11. The method of claim 7 wherein the determining further comprises identifying a greatest dissimilarity of the dissimilarities.

12. Apparatus for providing high-dimension validation of large language model (“LLM”) output, the apparatus comprising:
a multi-stage quantum generative adversarial network distribution engine that is configured to:
receive LLM output from the LLM, the LLM output responsive to a first query;
feed the LLM output to:
(a) a Quantum-Boosted Metaphor Analyzer;
(b) a Quantum-ML Multimodal Fact-Checker;
(c) a AI-Quantum Cultural Context Decoder;
(d) a Simulation-Integrated Verification System;
(e) an Insight Extraction Engine;
(f) a Hybrid Domain-specific Truth Tester;
(g) a Counterfactual Reasoning Accelerator; and
(h) a Quantum-inspired Fact Verification engine;
receive verification indications from:
(i) the Quantum-Boosted Metaphor Analyzer;
(j) the Quantum-ML Multimodal Fact-Checker;
(k) the AI-Quantum Cultural Context Decoder;
(l) the Simulation-Integrated Verification System;
(m) the Insight Extraction Engine;
(n) the Hybrid Domain-specific Truth Tester;
(o) the Counterfactual Reasoning Accelerator; and
(p) the Quantum-inspired Fact Verification engine; and
a high-dimension vector calculator that is configured to:
generate an indication report based on the indications;
determine a difference between the indication report and the LLM output; and,
based on the difference, define a cautionary space that is detectable in response to a second query.

13. The apparatus of claim 12 wherein the high-dimension vector calculator is further configured to formulate a virtual zone around an LLM output vector corresponding to a dissimilarity between the indication report and the LLM output.

14. The apparatus of claim 13 wherein the high-dimension vector calculator is further configured to embed the zone in a vector database.

15. The apparatus of claim 13 wherein the zone is defined as the LLM output vector corresponding to the greatest dissimilarity of a set of dissimilarities between the indication report and the LLM output.

16. The apparatus of claim 13 wherein the virtual zone is defined as an indication vector corresponding to a dissimilarity.

17. The apparatus of claim 12 further comprising, when the LLM output is first LLM output, an overlay engine that is configured to:
receive second LLM output corresponding to the second query; and
annotate the second LLM output based on the cautionary space.

18. The apparatus of claim 12 wherein the high-dimension vector calculator is configured to receive a virtual zone parameter from a user.

19. The apparatus of claim 18 wherein the parameter includes a reference vector that defines a perimeter of the zone.
